(19) United States
(12) Patent Application Publication
(10) Pub. No.: US 2010/0083790 A1
(43) Pub. Date: Apr. 8, 2010

(54) Flywheel device

(76) Inventors: Jon P. Graney, Miami Beach, FL (US); Gene Neillson, St. Cloud, FL (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/460,426

(22) Filed: Jul. 17, 2009

Related U.S. Application Data
(60) Provisional application No. 61/195,278, filed on Oct. 6, 2008.
(60) Provisional application No. 61/206,604, filed on Feb. 2, 2009.
(60) Provisional application No. 61/212,805, filed on Apr. 16, 2009.

(51) Int. Cl. F16F 15/305; C09J 4/04; B65H 81/00; B29C 65/52; B32B 27/04; B32B 27/12; G01M 19/00

(52) U.S. Cl. 74/572.21; 156/330.9; 156/184; 156/185; 428/297.4; 29/407.01

(57) ABSTRACT

A flywheel device includes a rotatable wheel that can have a rotatable composite rim structure with multiple radial layers of metallic material. The metallic material can have surfaces covered with a coat of cyanoacrylate type adhesive. Radially adjacent layers of the metallic material can be bonded together with a thermosetting polymer resin bonded to and between opposing coats of cyanoacrylate type adhesive covering the surfaces of the metallic material.

### RELATED APPLICATIONS

This application claims the benefit of U.S. Provisional Application No. 61/195,278, filed on Oct. 6, 2008, U.S. Provisional Application No. 61/206,604 filed on Feb. 2, 2009 and U.S. Provisional Application No. 61/212,805 filed on Apr. 16, 2009. The entire teachings of the above applications are incorporated herein by reference.

### BACKGROUND

A flywheel can be rotated to mechanically store energy and then release the energy when desired, for example, by generating electric power with an electric generator coupled to the flywheel. High energy flywheels are often made of high tensile strength carbon fiber composites which can allow them to rotate and withstand centrifugal forces at higher speeds without failing than a standard metal flywheel. However, carbon fiber flywheels tend to be relatively light in weight and typically run down quickly when connected to a generator.

### SUMMARY

The present invention can provide a flywheel device which can store and then release energy over a relatively large period of time. The flywheel device can include a rotatable wheel that can have a rotatable composite rim structure with multiple radial layers of metallic material. The metallic material can have surfaces covered with a coat of cyanoacrylate type adhesive. Radially adjacent layers of the metallic material can be bonded together with a thermosetting polymer resin bonded to and between opposing coats of cyanoacrylate type adhesive covering the surfaces of the metallic material.

In particular embodiments, a core member having an outer perimeter is included. The composite rim structure can be formed over the outer perimeter of the core member. Multiple radial layers of the metallic material can extend around the core member. The metallic material can include metallic fibers wound around the core member. Each layer of the metallic material can include twisted multiple strand metal wire cable positioned side by side. Each layer of the metallic material can have laterally adjacent cable bonded together with the thermosetting polymer resin. The coat of cyanoacrylate type adhesive can have a first layer and a second layer. The first layer can have a lower viscosity for penetrating into and between the multiple strands of the cable for bonding to and filling between the strands and to fill small cavities in the strands. The second layer can cover the first layer and can have a higher viscosity for further bonding and filling and provide a larger surface area for the thermosetting polymer resin to bond to. The thermosetting polymer resin can be selected from the group consisting of epoxy resin and polycarbonate resin. In some embodiments, the core member can include polymeric material and can be formed of composite material. Two side walls can be on opposite sides of the core member and the composite rim structure. The core member and the side walls can be formed of polycarbonate material laminated together with epoxy and clamped together with fasteners. A horizontal shaft can extend through the core member for supporting and for rotating the wheel about a horizontal axis. A motor can be rotatably connectable to the rotatable wheel for rotating the wheel to a desired speed. An electric generator can be rotatably connectable to the rotatable wheel for being rotated by the rotatable wheel. A clutch can be connected between at least one of the motor, the generator and the rotatable wheel. An enclosure can contain at least the rotatable wheel and surround the rotatable wheel in a low density environment. The rotatable wheel can have a diameter to width ratio of at least 2:1, and can have an outer diameter of at least 48 inches, a weight of at least 1700 lbs and can be capable of rotating at a speed of at least 1000 rpm. In some embodiments, the rotatable wheel can have a weight of at least 10,000 lbs, in other embodiments, a weight of at least 20,000 lbs, and in other embodiments, a weight of at least 30,000 lbs, and an outer diameter of at least 72 inches. In some embodiments, the rotatable wheel can rotate above 9000 rpm.

The present invention can also provide a flywheel device having a rotatable wheel including a composite core member with an outer perimeter. A composite rim structure can be formed over the outer perimeter of the core member. The composite rim structure can include twisted multiple strand metal wire cable positioned side by side and wound around the core member in multiple layers. The cable can have surfaces covered with coat of a cyanoacrylate type adhesive. Laterally adjacent cable and radially adjacent layers of the cable can be bonded together with a thermosetting polymer resin bonded to and between opposing coats of cyanoacrylate type adhesive covering the surfaces of the cable. The coat of cyanoacrylate type adhesive can have a first layer and a second layer. The first layer can have a lower viscosity for penetrating into and between the multiple strands of the cable for bonding to and filling between the strands and to fill small cavities in the strands. The second layer can cover the first layer and have a higher viscosity for further bonding and filling and provide a larger surface area for the thermosetting polymer resin to bond to.

The present invention can also provide a composite material, item, component or structure, including a material having fibers. A first layer of cyanoacrylate type adhesive can cover the material. The first layer can have a lower viscosity for penetrating into and between the fibers for bonding to and filling between the fibers and to fill small cavities in the fibers. A second layer of cyanoacrylate type adhesive can cover the first layer of cyanoacrylate type adhesive. The second layer can have a higher viscosity for providing further bonding and filling.

In particular embodiments, the material having fibers can include twisted multiple strand metal wire cable. In another embodiment, the material having fibers can be a web wound and bonded into a composite material core.

The present invention can also provide a method of forming a flywheel device including assembling multiple radial layers of metallic material. Surfaces of the metallic material can be covered with a coat of cyanoacrylate type adhesive. Radially adjacent layers of the metallic material together can be bonded together with a thermosetting polymer resin bonded to and between opposing coats of cyanoacrylate type adhesive covering the surfaces of the metallic material, thereby forming a rotatable wheel having a composite rim structure.

In particular embodiments, the composite rim structure can be formed over an outer perimeter of a core member by extending the multiple radial layers of the metallic material around the core member. Each layer of the metallic material can be formed by winding metallic fibers around the core member, and can include winding twisted multiple strand metal wire cable side by side and bonding laterally adjacent cable together with the thermosetting polymer resin. The bonding of radially adjacent layers of the metallic material can include winding an underlying layer of metallic material. Surfaces of the underlying layer of metallic material can be covered with an underlying coat of cyanoacrylate type adhesive. The underlying coat of cyanoacrylate type adhesive on the underlying layer of metallic material can be covered with a bonding coat of polymer thermosetting resin. A subsequent layer of metallic material can be wound over the underlying layer of metallic material and contact the bonding coat of polymer thermosetting resin. Surfaces of the subsequent layer of metallic material can be covered with a subsequent coat of cyanoacrylate type adhesive, thereby bonding the subsequent coat of cyanoacrylate type adhesive and the subsequent layer of metallic material to the bonding coat of polymer thermosetting resin. The underlying coat of cyanoacrylate type adhesive can be cured before applying the bonding coat of polymer thermosetting resin, and the bonding coat of polymer thermosetting resin can be cured before winding the subsequent layer of metallic material over the underlying layer of metallic material and the bonding coat of thermosetting polymer resin. Covering the surfaces of the metallic material with the coat of cyanoacrylate type adhesive can include covering the surfaces with a first layer of cyanoacrylate type adhesive having a lower viscosity for penetrating into and between the multiple strands of the cable for bonding to and filling between the strands and to fill small cavities in the strands. The first layer of cyanoacrylate type adhesive can be covered with a second layer of cyanoacrylate type adhesive having a higher viscosity for further bonding and filling and providing a larger surface area for the thermosetting polymer resin to bond to. The radially adjacent layers of the metallic material can be bonded with a thermosetting polymer resin selected from the group consisting of epoxy resin and polycarbonate resin. In some embodiments, the core member can be formed from polymeric material and can be formed of composite material. Two side walls can be secured on opposite sides of the core member. The core member and the side walls can be formed from sheets of polycarbonate material laminated together with epoxy and clamped together with fasteners. A horizontal support shaft can extend through the core member for supporting and rotating the rotatable wheel about a horizontal axis. A motor can be included that is rotatably connectable to the rotatable wheel for rotating the wheel to a desired speed. An electric generator can be included that is rotatably connectable to the rotatable wheel for being rotated by the rotatable wheel. A clutch can be rotatably connected between at least one of the motor, generator, and the rotatable wheel. At least the rotatable wheel can be contained within an enclosure which can surround the rotatable wheel in a low density environment. The rotatable wheel can have a diameter to width ratio of at least 2:1, and can have an outer diameter of at least 48 inches, a weight of at least 1700 lbs, and can be capable of rotating at a speed of at least 1000 rpm. In some embodiments, the rotatable wheel can be formed with a weight of at least 10,000 lbs, in other embodiments a weight of at least 20,000 lbs, and in other embodiments, a weight of at least 30,000 lbs, and an outer diameter of at least 72 inches. In some embodiments, the rotatable wheel can be capable of rotating above 9000 rpm.

The present invention can also provide a method of forming a flywheel device including forming a composite core member having an outer perimeter. Multiple layers of twisted multiple strand metal wire cable can be wound and positioned side by side around the outer perimeter of the core member. Surfaces of the cable can be covered with a coat of cyanoacrylate type adhesive. Laterally adjacent cable and radially adjacent layers of the cable can be bonded with a thermosetting polymer resin bonded to and between opposing coats of cyanoacrylate type adhesive covering the surfaces of the cable. The coat of cyanoacrylate type adhesive can have a first layer and a second layer. The first layer can have a lower viscosity for penetrating into and between the multiple strands of the cable for bonding to and filling between the strands and to fill small cavities in the strands. The second layer can cover the first layer and have a higher viscosity for further bonding and filling and providing a larger surface area for the thermosetting polymer resin to bond to, thereby forming a rotatable wheel having a composite rim structure formed over the core member.

The present invention can also provide a method of forming a composite material, item, component or structure, including covering a material having fibers with a first layer of cyanoacrylate type adhesive having a lower viscosity for penetrating into and between the fibers for bonding to and filling between the fibers and to fill small cavities in the fibers. The first layer of cyanoacrylate type adhesive can be covered with a second layer of cyanoacrylate type adhesive having a higher viscosity for providing further bonding and filling.

In particular embodiments, twisted multiple strand metal wire cable can be covered with the layers of cyanoacrylate type adhesive. In another embodiment, the material having fibers can be a web. The web can be wound and bonded into a composite material core.

The present invention can also provide a method of balancing a flywheel including rotatably supporting the flywheel about a horizontal axis. The flywheel can be statically balanced by allowing a heavy side of the flywheel to rotate to a bottom position and adding weight to a top position or removing weight at the bottom position. The flywheel can be dynamically balanced with a laser balancing system by applying sensor and laser reflective materials to the flywheel and rotating the flywheel from about 100 to 700 rpm. Weight can be added or removed as indicated by the laser balancing system by drilling at least one hole in a side of the flywheel at indicated locations, and when adding weight, inserting at least one weighted member in the at least one hole.

In particular embodiments, the at least one weighted member is at least one metallic member. Surfaces of the at least one hole and the at least one metallic member can be each covered with a coat of cyanoacrylate type adhesive. The at least one metallic member can be secured within the at least one hole with thermosetting polymer resin bonding the coat of cyanoacrylate type adhesive covering the at least one hole to the coat of cyanoacrylate type adhesive covering the at least one metallic member. The coat of cyanoacrylate type adhesive can be applied in first and second layers. The first layer can have a lower viscosity for penetrating and bonding to the surfaces and filling small cavities in the surfaces. The second layer can have a higher viscosity for further bonding and filling and providing a larger surface area for the thermosetting polymer resin to bond to. A thermosetting polymer resin can be employed that is selected from the group consisting of epoxy resin and polycarbonate resin.

The present invention can also provide a method of suppressing vibration in a flywheel rotating about a horizontal axis, including providing the flywheel with a composite core member for limiting vibration propagation across the core member. The flywheel can be provided with a composite rim structure formed around the core member having metallic material wound around the core member in multiple layers. The metallic material can have surfaces covered with a coat of cyanoacrylate type adhesive. Radially adjacent layers of the metallic material can be bonded together with a thermosetting polymer resin bonded to and between opposing coats of cyanoacrylate type adhesive covering the surfaces of the metallic material for limiting vibration propagation across the rim structure.

The present invention can also provide a method of storing energy including providing a composite flywheel having an outer diameter of at least 48 inches and a weight of at least 10,000 lbs The flywheel can be rotated about a horizontal axis at a speed of at least 1000 rpm.

In particular embodiments, the flywheel can be provided with a weight of at least 20,000 lbs, in other embodiments a weight of at least 30,000 lbs, and an outer diameter of at least 72 inches. The flywheel can be rotated above 9000 rpm. The flywheel can be provided with a composite rim structure having multiple radial layers of metallic material. The metallic material can have surfaces covered with a coat of cyanoacrylate type adhesive. Radially adjacent layers of the metallic material can be bonded together with a thermosetting polymer resin bonded to and between opposing coats of cyanoacrylate type adhesive covering the surfaces of the metallic material. In some embodiments, the flywheel can be provided with a core member formed of polymeric material.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic drawing of one embodiment of a flywheel device in the present invention.

FIGS. 2 and 3 are schematic drawings of one embodiment of a clutch, a fluidic clutch.

FIGS. 4 and 5 are schematic drawings of a flywheel in the present invention.

FIG. 6 is a schematic drawing of another embodiment of a clutch, a magnetic clutch.

FIG. 7 is another schematic drawing of a flywheel in the present invention.

FIG. 8 is a side view of an embodiment of a support shaft for a flywheel.

FIGS. 9 and 10 are side views of depicting the formation of laminations for an embodiment of a flywheel spool member.

FIG. 11 is a side view of an embodiment of a flywheel spool member in the present invention.

FIG. 12 is a front view of the flywheel spool member of FIG. 11.

FIG. 13 is a side view of a flywheel spool member mounted on bearings.

FIG. 14 is a side view of another flywheel spool member arrangement.

FIG. 15 is a side view of a flywheel spool member depicting cable attachment to the core member.

FIG. 16 is a side view of a flywheel spool member having a layer of cable wound on the core member.

FIG. 17 is a perspective view of an arrangement depicting cable being wound onto a flywheel spool member.

FIG. 18 is a schematic drawing of an arrangement for applying cable onto a flywheel spool member.

FIG. 19 is a schematic cross sectional drawing depicting two strands in a cable bonded together.

FIG. 20 is a schematic cross sectional drawing depicting two layers of cable on a flywheel spool member.

FIG. 21 is a schematic cross sectional drawing depicting one cable in FIG. 20.

FIGS. 22 and 23 are perspective views depicting layered cable on a flywheel spool member.

FIG. 24 is a perspective view of a portion of an embodiment of a flywheel within an enclosure.

FIGS. 25 and 26 are side and front views of a flywheel and a balancing arrangement.

FIG. 27 is a schematic side sectional view of a balancing weight bonded within a hole in the flywheel.

FIG. 28 is a perspective view of another flywheel device in the present invention.

FIG. 29 is a perspective view of the flywheel device of FIG. 28 with the outer cover removed.

FIG. 30 is a top view of FIG. 29.

FIG. 31 is a side view of FIG. 29.

FIG. 32 is an end view of FIG. 29.

FIG. 33 is a schematic drawing of another embodiment of a core.

### DETAILED DESCRIPTION

A description of example embodiments of the invention follows.

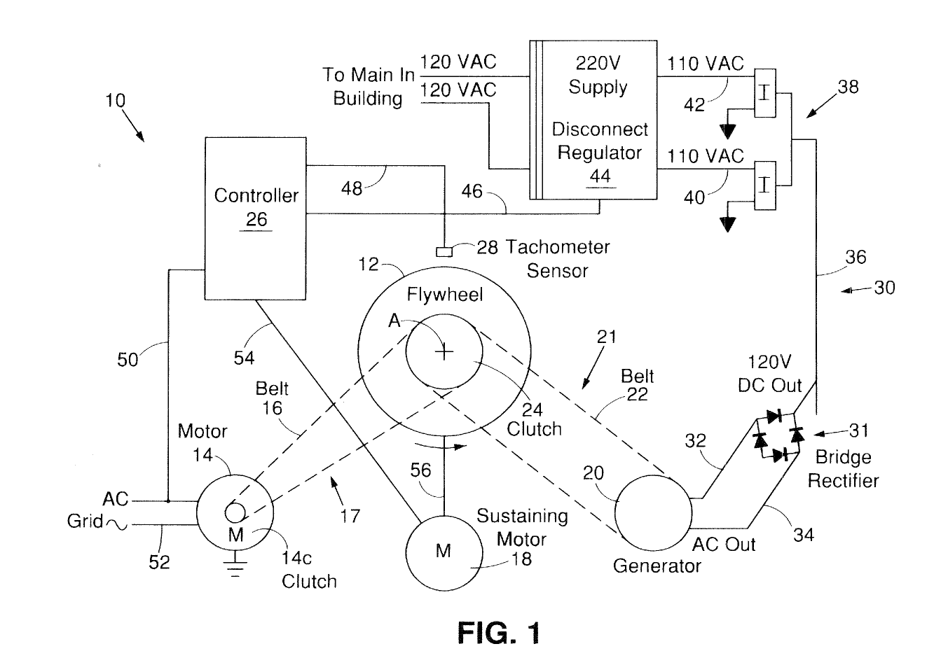

Referring to FIG. 1, in one embodiment of the present invention, flywheel device, apparatus or system 10 can include a rotatable wheel or flywheel 12, which can be rotatably coupled to, and rotated up to a desired operating speed by a motor 14. The flywheel 12 can often range in weight and size for example, about 1700 lbs and about 4 feet in diameter, can be about 50,000 lbs and about 20 feet in diameter, and some cases, can be larger, for example, 70,000 lbs. The width of the flywheel 12 can also vary depending upon the desired diameter and weight. The motor 14 can be rotatably connectable to the flywheel 12 via a transmission 17, such as a belt 16 connected to pulleys on the motor 14 and the flywheel 12. The motor 14 can have a clutch 14c for engaging and disengaging the motor 14 from the flywheel 12. A smaller sustaining motor 18 can be included and can be rotatably connectable to the flywheel 12 after the flywheel 12 is up to speed, and used to maintain the desired speed of flywheel 12. The sustaining motor 18 can be rotatably engageable and disengageable to the flywheel 12 by a transmission 56 which can include a belt and pulleys and a clutch. A generator 20 can be rotatably connected, engaged or coupled to the flywheel 12 when needed or desired, for rotation by the flywheel 12 for generating electrical power. The generator 20 can be rotatably connectable to the flywheel 12 by a transmission 21, for example, a belt 22 connected to pulleys on the flywheel 12 and the generator 20. The transmission 21 can include a clutch 24 on the flywheel 12 which can engage and disengage the flywheel 12 from the generator 20, and can control the rotational speed of the generator 20 to a desired level. The electrical power from generator 20 can be regulated or converted into the desired level or form by an electrical power regulator 30. Electrical power, for example, 120 VAC and/or 220 VAC, can be provided from regulator 30 to the desired destination, for example to a building through a disconnect regulator 44. A controller 26 can be in electrical communication with motor 14, motor 18 and flywheel 12 for controlling the operation of motor 14 and motor 18. Controller 26 can also be used to control the operation of one or more of the clutches 14c and 24, generator 20, electrical power regulator 30, and disconnect regulator 44. The controller 26, motor 14 and motor 18 can be powered by electricity from the electrical grid 52.

In one operational use, flywheel 12 can be rotated up to speed at off peak times of the day, for example, between 9:00 p.m. and 9:00 a.m., and then used to run or power the generator 20 to produce electrical power at peak times of the day, for example, between 9:00 a.m. to 9:00 p.m. The motor 14 can be rotatably engaged to flywheel 12 by transmission 17 to rotate flywheel 12 to the desired speed, for example, from 1000 rpm to 9000 rpm, or above. Transmissions 56 and 21 can be disengaged while the flywheel 12 is brought up to speed. Once the flywheel 12 is at the desired speed, transmission 17 can be disengaged and motor 14 turned off. If electrical power is not to be generated for some time, the sustaining motor 18 can be rotatably connected via transmission 56 to the flywheel 12 to maintain the speed of the flywheel 12. The sustaining motor 18 can be a smaller motor than motor 14 to use less power, and can be run continuously or intermittently. Alternatively, the motor 14 can be run periodically instead of using a sustaining motor 18 to maintain a desired speed of the flywheel 12. When power generation is desired, the transmissions 17 and/or 56 can be disengaged, and transmission 21 can be engaged to rotatably connect flywheel 12 with generator 20, to allow flywheel 12 drive and rotate generator 20, and generate electrical power. If motor 14 and motor 18 are powered from the electrical grid 52, motors 14 and/or 18 can be run at night to bring flywheel 12 up to speed when the cost of electricity is low, and the motors 14 and/or 18 can be turned off during the day when the cost of electricity is high. Electricity needed during the day can be drawn off the generator 20 powered by the rotating flywheel 12, thereby providing a cost savings. The motors 14 and/or 18 can also be powered constantly 24 hours a day from the grid 52 while constantly producing electrical power with generator 20 and still provide cost savings, because electricity can be drawn evenly from the grid 52 over the entire day for powering the motors 14 and/or 18, averaging the cost of electricity drawn over both off peak and peak times. Such a flywheel device 10 that is constantly powered by a motor while constantly producing electrical power with generator 20, can provide power to a building 24 hours a day.

In one embodiment, the generator 20 can be an AC generator in which the rotation can be controlled by clutch 24 to the desired speed, for example, about 1800 rpm to generate AC electrical power at about 60 Hz. Another common speed is about 3600 rpm. The speed can also be varied to produce other frequencies such as 50 Hz, or in other situations where, for example, if generator 20 is a DC generator. The generator 20 can be electrically connected to electrical power regulator 30 via lines 32 and 34. The electrical power regulator 30 can include a bridge rectifier 31 which is connected via line 36 to an inverter 38. The bridge rectifier 31 can provide the inverter 38 with DC electrical power, for example 120V, and the inverter 38 can provide the disconnect regulator 44 with AC electrical power, for example 110V via lines 40 and 42. The controller 26 can be in electrical communication with motor 14, for example, via line 50, and in electrical communication with sustaining motor 18, for example, via line 54, for control or operation. A sensor 28, for example, a rotational speed sensor or a tachometer, can be positioned relative to the flywheel 12 or shaft 58 for sensing rotational velocity or speed of the flywheel 12, and can be in electrical communication with the controller 26, for example, via line 48. The controller 26 can control operation of motors 14 and 18, and generator 20 based on the speed of flywheel 12 sensed by sensor 28. In one embodiment, for illustration, flywheel 12 can be 48 inches in diameter, 8 inches wide, 1700 lbs. in weight, rotating at 3600 rpm, motor 14 can be a 7.5 Hp AC motor, and sustaining motor 18 can be ⅓ Hp AC motor. Motors 14 and 18 and generator 20 can be 3 phase or single phase. It is understood that the size and weight of flywheel 12 can vary, and the size or electrical specifications of motors 14 and 18, and generator 20 can vary, and can be AC or DC. The motor 14 can be used to provide some braking the flywheel 12 if desired.

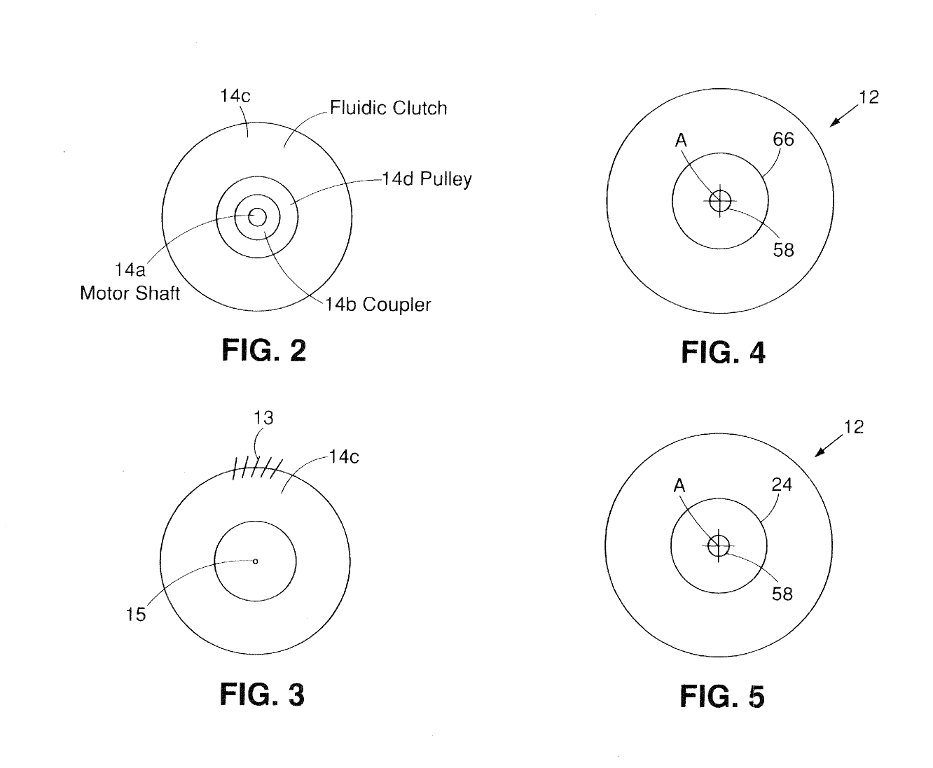

FIGS. 2 and 3 depict an embodiment of clutch 14c. The clutch 14c can be secured to the drive shaft 14a of motor 14 by a coupler 14b, and can include a pulley 14d for engaging and driving belt 16. The pulley 14d can be metal such as steel, or can be polycarbonate. The clutch 14c can be a fluidic clutch and have a fluidic control regulator 15 for controlling the rate of fluid flow through or within the clutch 14c. The fluid flow rate can control the amount of slip of the clutch 14c. For a heavy flywheel 12, slip provided by clutch 14c can allow motor 14 to drive flywheel 12 without damaging the motor 14, transmission 17, or flywheel 12, for example, from a standing start. Cooling fins 13 can provide cooling.

Referring to FIGS. 4 and 5, the flywheel 12 can include, or can be mounted in an upright position or orientation on a horizontal flywheel support shaft 58, which can be supported by bearings about a horizontal axis A. A pulley 66 can be mounted to the shaft 58 on an input, supply or one side of the flywheel 12, and can be included in transmission 17 for engagement and driving by belt 16 and motor 14. A clutch 24 can be mounted to the shaft 58 on an opposite, output or second side of the flywheel 12 for engaging and driving belt 22 and generator 20, and can be part of transmission 21. In some embodiments, the pulley 66 and clutch 24 can be mounted to flywheel 12 on the same side. Transmission 56 can be connected to flywheel 12 on the same side as pulley 66, and pulley 66 can be a double pulley for being rotatably connected to sustaining motor 18. In addition, the pulley 66 and/or clutch 24 can be mounted to the side wall of flywheel 12 instead of shaft 58. Pulley 66 can be metal, such as steel, or can be polycarbonate.

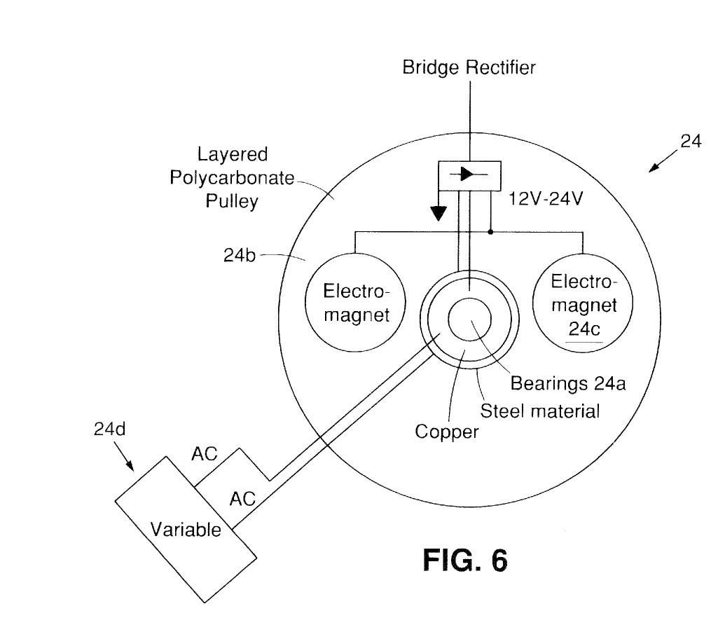

Referring to FIG. 6, in one embodiment, clutch 24 can be a magnetic clutch which can be controlled by a phase lock loop that measures the speed of flywheel 12 with sensor 28. The clutch 24 can include a pulley 24b which can engage and drive belt 22 and generator 20. The pulley 24b can be a layered polycarbonate pulley, and can be mounted to shaft 58 with bearings 24a. Alternatively, pulley 24b can be a metal pulley. A controllable variable voltage input 24d, for example AC current, can be provided to electromagnets 24c mounted to pulley 24b. The electromagnets 24c can grab metal plates mounted in the wall of the flywheel 12 for driving pulley 24b. An example of a configuration including a bridge rectifier, and copper and steel rings mounted around bearings 24a is depicted in FIG. 6. In other embodiments, other arrangements or types of clutches can be employed. In embodiments where pulley speeds are above 6500 feet/min rim speed, polycarbonate pulleys can be used where needed to withstand such speeds.

In some embodiments, the sustaining motor 18 can be omitted. The specifications, configuration and components of electrical power regulator 30 can vary depending upon the type of power generated by generator 20, and can vary in the method employed for converting power to the desired level and form. In some embodiments, instead of controlling the frequency of AC power with a clutch 24, electrical power regulator 30 can have a configuration for providing electrical power with a constant frequency, for example, 60 Hz or 50 Hz, regardless of the rotational speed of generator 20. Different levels and forms of electrical power can be provided through disconnect regulator 44 as desired. The generator 20 can also be a motor/generator, used as a motor to bring the flywheel 12 up to speed, as well as a generator to generate electrical power. Other suitable transmissions can be used as known in the art instead of pulleys and belts, including drive shafts that are rotatably coupled together and transmissions having gears, and other suitable clutches can be used. In other embodiments, the flywheel 12 can be brought up to speed mechanically, for example, by wind, water, internal combustion or steam power, etc., where motors 14 and 18 can be omitted. In addition, flywheel 12 can be connected to devices other than a generator 20 for using the stored energy, for example, mechanical devices or machinery. Flywheel 12 can be used in conjunction with solar and wind farms, as well as electrical power plants, including hydroelectric and conventional power plants.

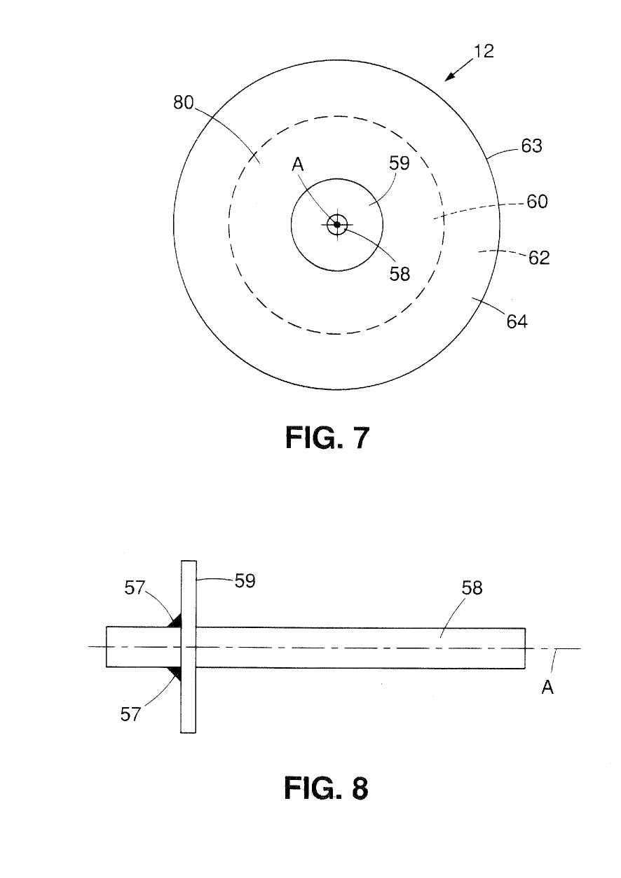

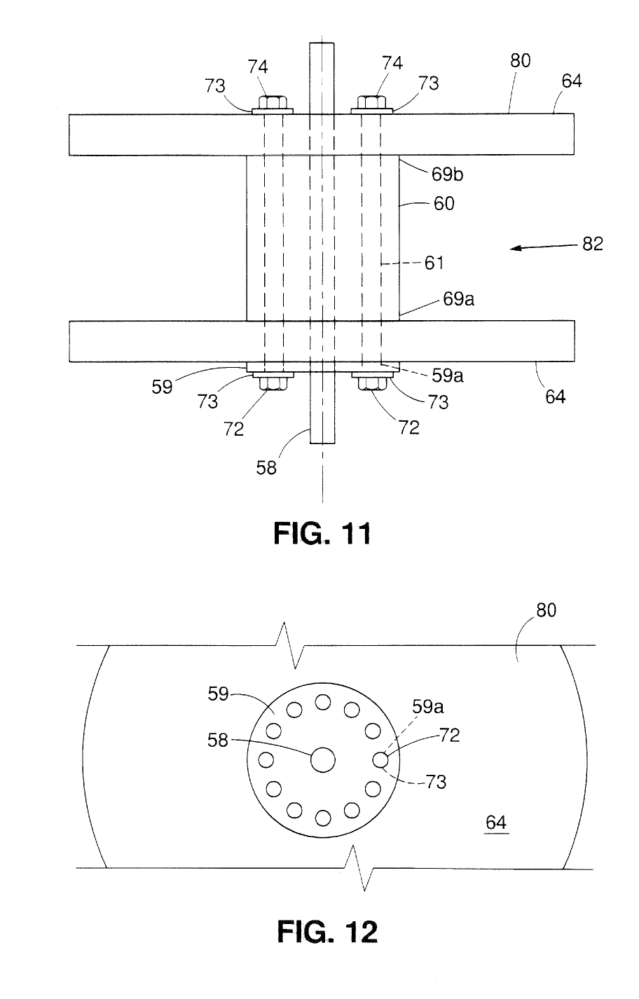

FIG. 7 depicts an embodiment of flywheel 12 which can be or include a variable density composite material polylaminate. The flywheel 12 can have an inner or central core or core member 60, surrounded by a composite rim or rim structure 62. The core 60 can have a generally circular perimeter or circumference. A flange 59 can be secured to shaft 58 with welds 57 (FIG. 8), which can allow securement or mounting to the core 60 with fasteners, such as screws or bolts 72 (FIGS. 11 and 12). In some embodiments, the flange 59 and shaft 58 can also be secured to the composite rim 62. The core 60 can be relatively light in weight in comparison to the rim 62, and can have a vibration damping or suppressing construction which can be formed of composite materials, and can include polymeric materials. The rim 62 can be formed of layers of metallic material such as metallic or steel cable 84, bonded to each other and to core 60 to provide the flywheel 12 with a large amount of weight or mass, which can be concentrated at the perimeter to provide a high moment of inertia. The rim 62 can also have a vibration damping or suppressing construction. The core 60 can be or can be part of a spool member or spool 80 over which the rim 62 is formed. In one embodiment, the spool 80 can include two flat circular or disc shaped sides or walls 64 on opposite axial ends 69a and 69b of core 60, and have an annular region 82 there between (FIG. 11) and surrounding core 60.

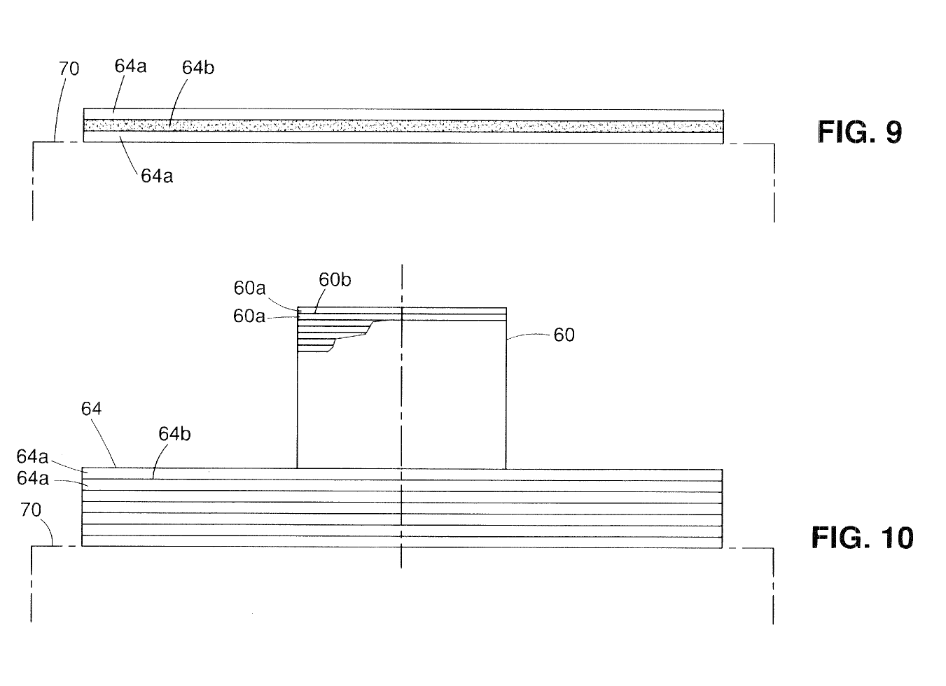

Referring to FIGS. 9 and 10, in one embodiment, the spool 80 can be formed of polymeric material such as polycarbonate material, and can be laminated. In order to form an embodiment of a laminated spool 80 having sides 64, each side 64 of the spool 80 can be formed by laminating flat sheets or discs 64a of polymeric material such as polycarbonate together with a layer of adhesive 64b between the sheets 64a. The adhesive 64b can be slow set epoxy and can be in a continuous layer. The sheets 64a can be laminated together while resting on a flat horizontal table 70, and can be laminated using clamps and/or weights. Each side 64 can include multiple sheets 64a, and after each sheet 64a is laminated, the lamination assembly can be turned over or rotated 180° to laminate the next sheet 64a on the opposite side. The core 60 can be formed in a similar manner by laminating flat sheets or discs 60a together with adhesive 60b, such as epoxy. The number and diameter of sheets 60a laminated for the core 60 can depend upon the thickness of the sheets 60a and the desired thickness or width and diameter of the core 60. For example, for illustration purposes, sheets 60a can be ¼ inch thick, and 120 sheets 60a which are 36 inches in diameter can be laminated together to form a core 60 that is about 30 inches wide and 36 inches in diameter. Sheets 64a for the sides 64 can also be ¼ inch thick, and 8 sheets 64a which are 120 inches in diameter can be laminated together to form sides 64 about 2 inches wide and 120 inches in diameter. The diameter of the sides 64 can also be about the diameter of the flywheel 12. The width and diameter of the core 60 and sides 64 can vary, depending upon the size and weight of the flywheel 12.

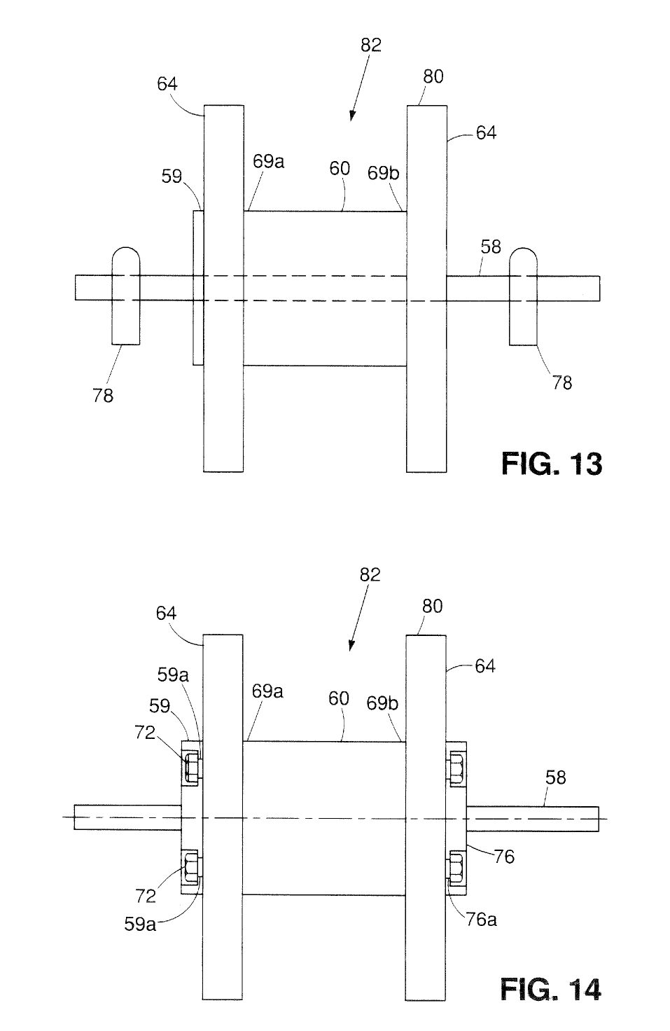

The core 60 and the sides 64 can be aligned on an axis and laminated together with epoxy while clamped or under weights. Referring to FIGS. 11 and 12, the sides 64 and core 60 can be bolted or clamped together against flange 59 of shaft 58 with a series of bolts 72, washers 73 and nuts 74, via holes 59a in flange 59 and holes 61 through core 60 and sides 64. The holes 59a and 61 can be predrilled. This can rotatably lock the shaft 58 to the core 60 and spool 80. Alternatively, shaft 58 can be rotationally locked to core 60 and spool 80 by other suitable methods known in the art, such as with keyways, pins, set screws, splines, etc. Referring to FIG. 13, the shaft 58 can then be supported by bearings 78, which can be mechanical bearings, for example, pillow block bearings. The heavy grease in the bearings 78 can be removed and replaced with light lubricants, for example light oil or graphite lubricant. The bearings 78 can also be other suitable types of bearings, such as roller, ball, needle, magnetic, bushings, fluid dynamic bearings, etc. At various times in the process, alignment and rotational concentricity of spool 80 can be checked. In some situations, some misalignment or runout can be removed by turning the spool 80 on a lathe. If desired, referring to FIG. 14, the sides 64 and core 60 can be clamped between flange 59 and a plate 76. Holes 59a in the flange 59 and holes 76a in plate 76 can be countersunk or counterbored so that bolts 72 and nuts 74 can be recessed. In some embodiments, the spool 80 can be formed in one integral piece, or the core 60 and the sides 64 can be individual integral pieces which are assembled together. In other embodiments, the sides 64 can be formed during or after the rim 62 is formed, and can be formed of composite materials, including carbon fibers, bonded, to the rim 62. In addition, in some embodiments, the sides 64 can be omitted. The core 60 can be formed of other suitable composite materials, or can be a solid single material such as a polymer, for example, polycarbonate, or metals, such as aluminum, steel, iron, titanium, etc., or include a composite of such materials.

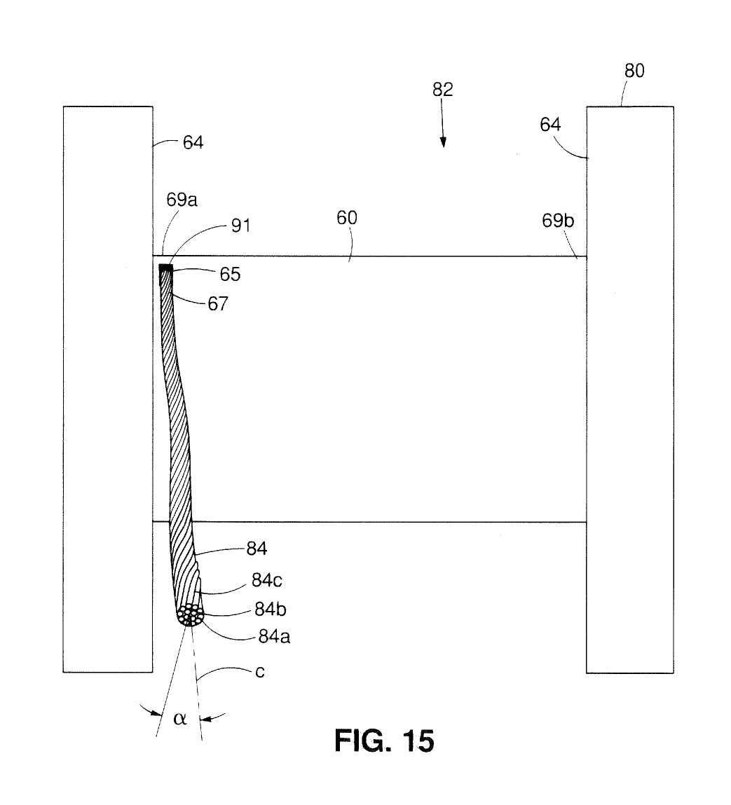

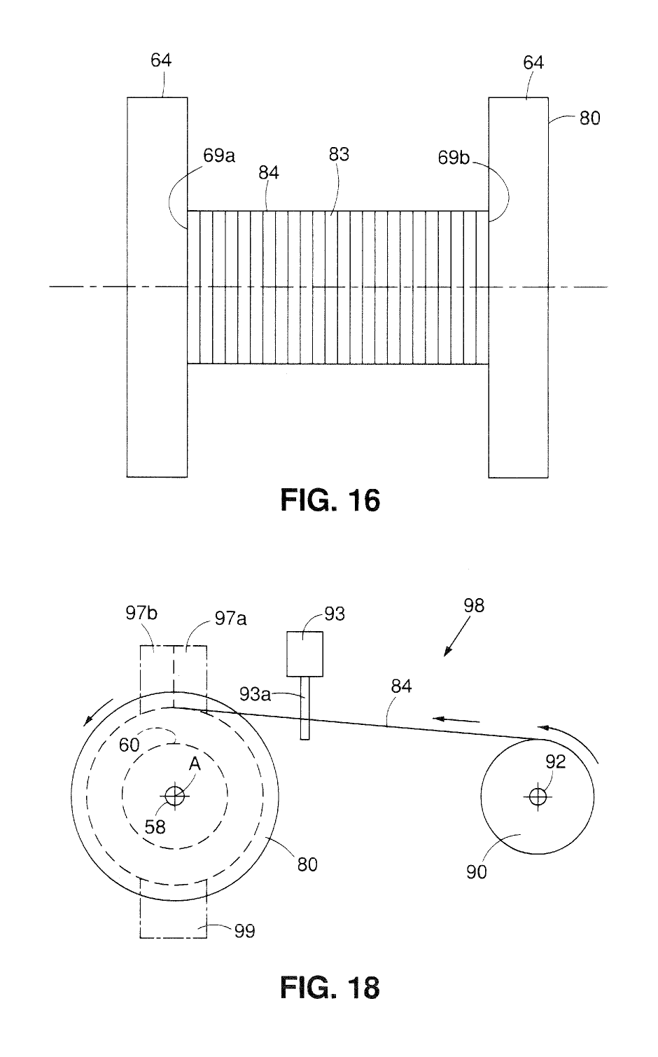

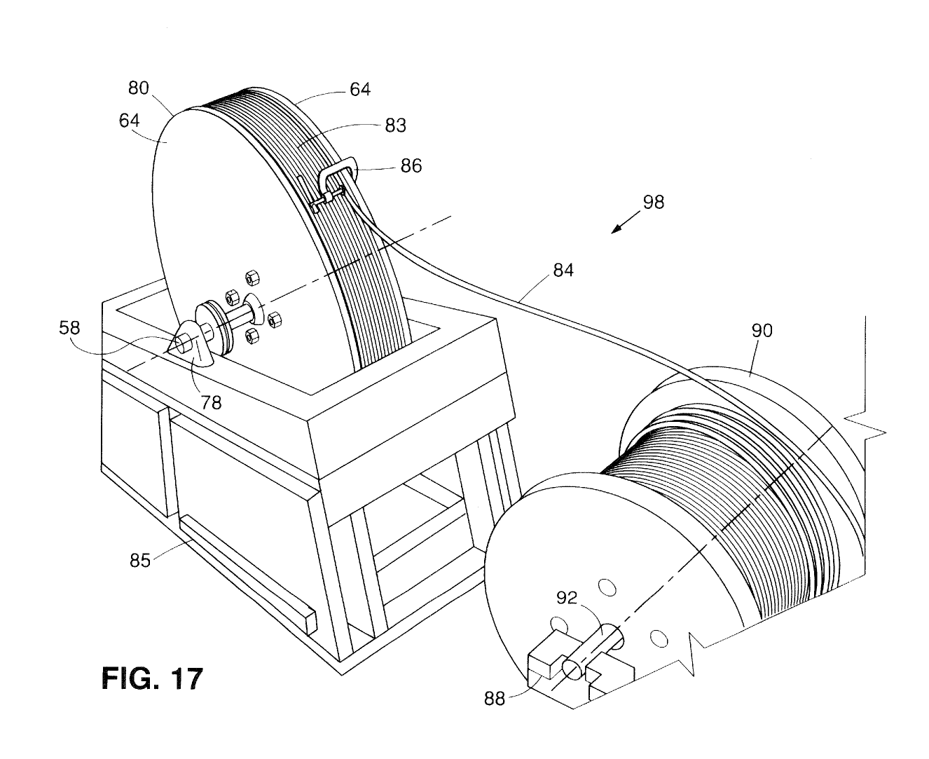

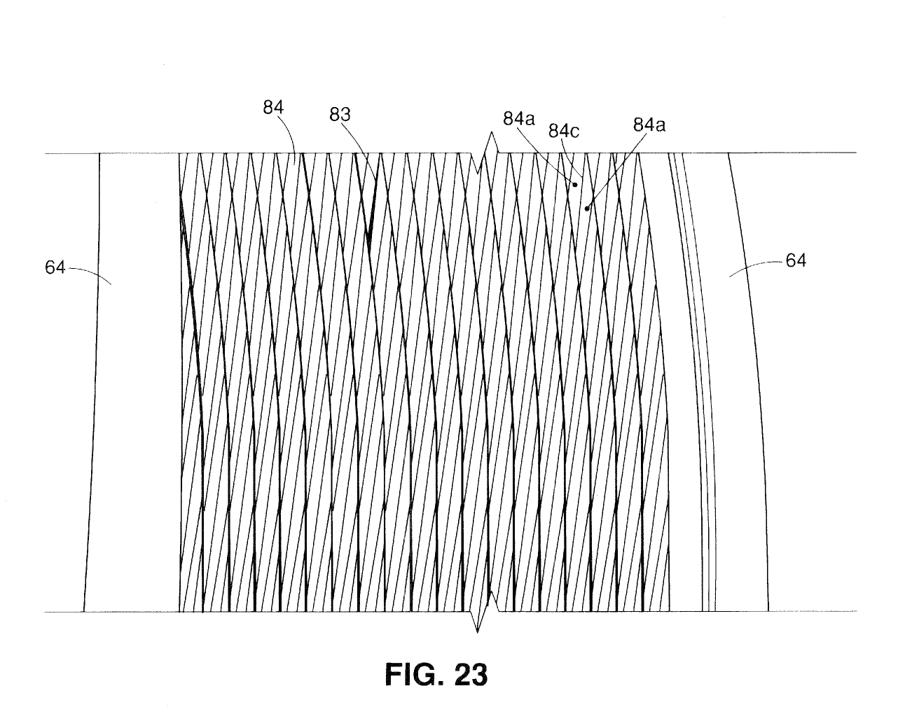

Referring to FIGS. 15-23, in one embodiment, to form the rim 62 of the flywheel 12, metallic material such as a metallic cable 84 can be applied in radial layers around core 60. Cable 84 can have any suitable diameter, and in one embodiment can have a diameter of about ¼ inches. The cable 84 can be a steel multistrand cable having a series of twisted individual strands 84a (for example, 7×19 strands). It is understood that other suitable diameters and cable or strand configurations can be employed. The cable 84 can be applied to the core 60 and spool 80 with an unwind/windup apparatus, arrangement or configuration 98 (FIGS. 17 and 18). The spool 80 can be mounted to a base, stand, or frame 85 in an upright position with bearings 78 secured to frame 85 and rotatably supporting horizontal shaft 58 about horizontal axis A. A hole 65 can be drilled in the core 60 or spool 80 at one axial end 69a of the core 60 or side 64 for insertion and attachment of an end 67 of the cable 84 with adhesive (FIG. 15), for example, epoxy and/or cyanoacrylate (CA) type or class adhesive 91. Alternatively, the end 67 of the cable 84 can be secured to the core 60 or spool 80 by mechanical fasteners, clamps, etc. The cable 84 can then be unwound from a cable storage or supply spool 90 and wound onto the spool 80. The storage spool 90 can have a horizontal shaft 92 supported by a support stand 88 for rotatably unwinding cable 84 from spool 90. In other embodiments, the storage spool 90 can be rotated on a vertical axis and shaft. Referring to FIG. 16, the cable 84 can be wound circumferentially onto or around core 60 side by side or laterally adjacent to each other to form a layer 83 of cable 84 extending circumferentially around the core 60 and along the axial direction of the core 60 between axial ends 69a and 69b. A guiding device 93 with a guide 93a can guide the cable 84 in the desired manner to form layer 83. Alternatively, guiding can be done manually. After a wound layer 83 is completed, a securing device or clamp 86 (FIG. 17) can be used to hold the layer 83 of cable 84 stationary.

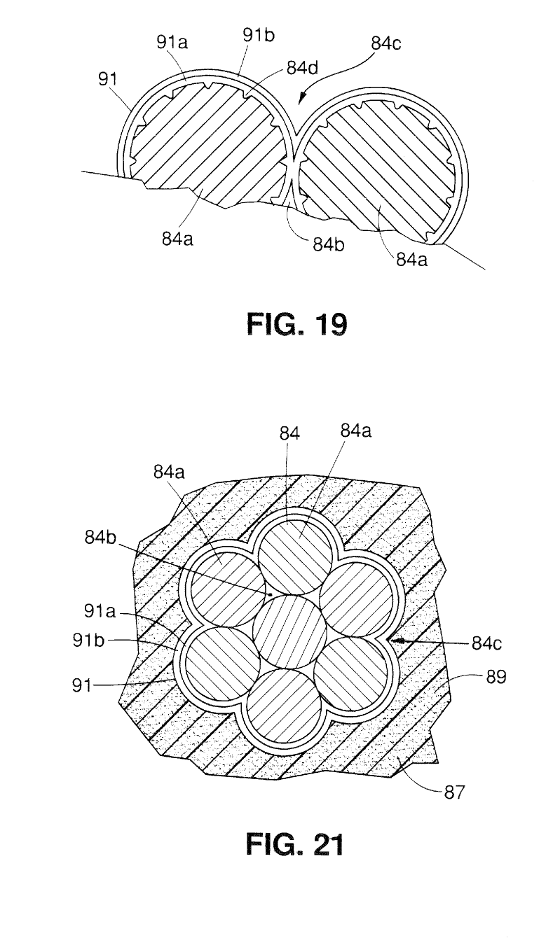

The layer 83 of cable 84 on core 60 can then be saturated with cyanoacrylate (CA) type adhesive 91 which can bond the layer 83 of cable 84 in place on core 60. Adjacent cables 84 which touch each other can also be bonded together. The CA adhesive 91 can also penetrate and fill the spaces, crevices or cavities 84b between the strands 84a of the cable 84, bonding the strands 84a together, and bonding, locking or stiffening the cable 84 in a curved or radiused configuration around core 60. The CA adhesive 91 can penetrate and fill small surface cavities, pits, cracks or crevices 84d in the strands 84a themselves (FIG. 19). The CA adhesive 91 can be applied manually, or by a dispensing station, device or apparatus 97a in an automated fashion, and can be applied in two layers 91a and 91b. The first layer 91a of CA adhesive 91 can be of low or lower viscosity, for example, thin viscosity glue with an instant set time, for bonding to the underlying surface or core 60, and penetrating into and between the multiple strands 84a of the cable 84 for bonding to and filling between the strands 84a and to fill the small cavities 84d in the strands 84. The second layer 91b of CA adhesive 91 can have a higher viscosity, for example, a medium viscosity gap filling glue, that is medium set with a set time of about 5-20 seconds, for covering the first layer 91a for further bonding and filling and increasing the size or surface area of the cable 84 and CA adhesive 91 composite or laminate. The second layer 91b can be applied after the first layer 91a has set or cured. The spool 80 or core 60 can be slowly rotated while the layers 91a and 91a of CA adhesive 91 is applied to prevent CA adhesive 91 from leaking or dripping off the cable 84 or spool 80. The CA adhesive 91 types can be standard commercially available cyanoacrylate adhesive, for example available from companies such as 3M. To ensure strength, the CA adhesive 91 can be applied without the use of accelerators. If there are large gaps that require filling, an even higher viscosity CA adhesive 91 can be employed, such as a thick viscosity thick set glue with a set time exceeding 60 seconds. The particular viscosities used for layers 91a and 91b can be chosen or varied as desired.

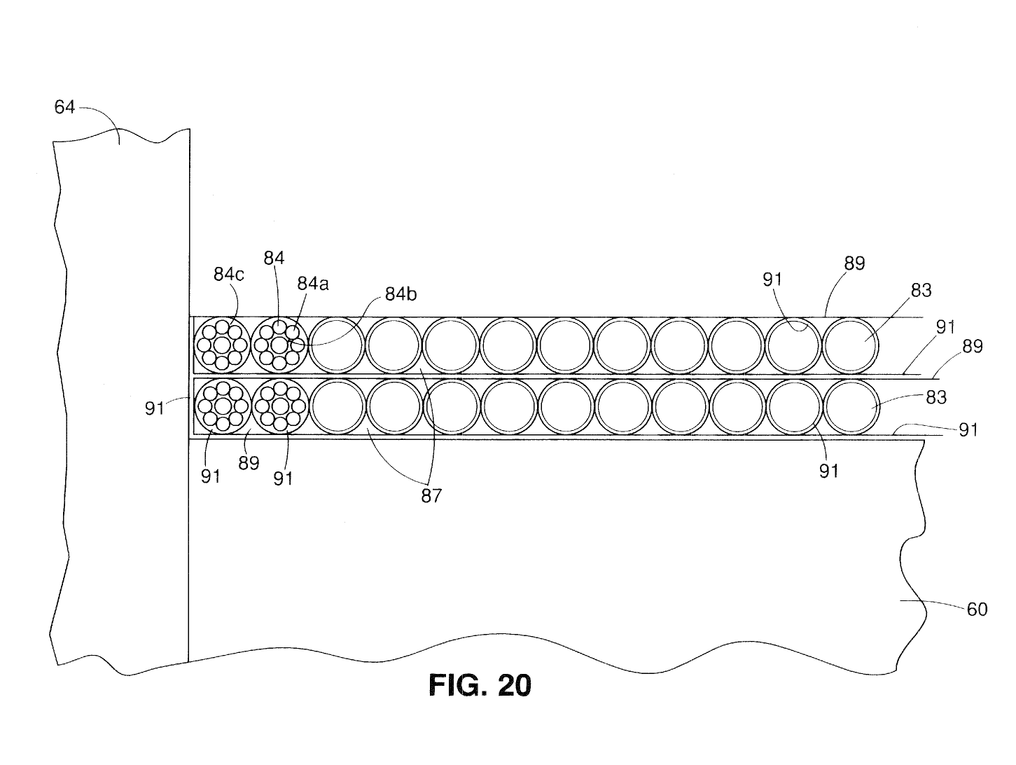

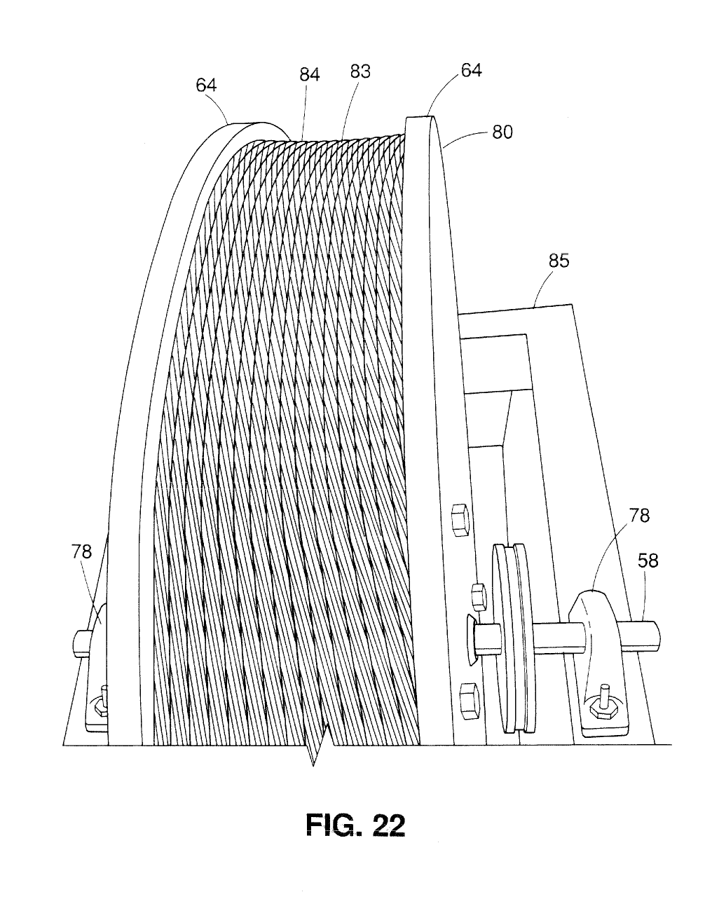

A bonding layer or coat of thermosetting polymer resin 89, for example, commercially available epoxy resin or polycarbonate resin, can be applied over the layer 83 of cable 84 and the coat of CA adhesive 91 (FIGS. 20 and 21). The polymer resin 89 can be applied after the CA adhesive 91 has cured. The polymer resin 89 can be a slow set resin to allow the resin 89 to saturate the layer 83 of cable 84, covering the CA adhesive 91 and filling cavities 87 between the cables 84 as well as cavities or crevices 84c on the surface of the cable 84 between the individual strands 84a, and if not already filled, cavities 84b in the cable 84. The resin 89 can be applied manually, or by a dispensing station, device or apparatus 97b in an automated fashion. The spool 80 or core 60 can be slowly rotated while the layer of polymer resin 89 cures or sets. If desired, an apparatus device or member 99 can be used to smooth or keep the CA adhesive 91 and/or resin 89 in place on the layer 83 while setting. Although shown in the bottom position in FIG. 18, device 99 can be in other locations, and in some embodiments, can rotate around the spool 80. The resin 89 can bond to the CA adhesive 91 covering the cable 84 and by filling the spaces, cavities or gaps 87 between the cables 84, can further bond the cable 84 to the underlying surface or core 60 and the laterally adjacent cables 84 to each other. Laterally adjacent cables 84 in a layer 83 can be bonded together with polymer resin 89 being bonded to and between opposing coats of CA adhesive 91 covering the adjacent cables 84. The CA adhesive 91 can also be applied to the sides 64 of spool 80 so that the sides 64 can be bonded to adjacent cables 84 by polymer resin 89 being bonded to and between opposing coats of CA adhesive covering the sides 64 and adjacent cables 84.

After each layer 83 of cable 84 is bonded around the core 60 with polymer resin 89, another layer 83 of cable 84 can be applied in a similar manner. The next layer 83 can be applied after the polymer resin 89 has set or cured. Subsequent radial layers 83 of cable 84 can be applied and bonded to the previous layer 83 by further application of CA adhesive 91 and polymer resin 89 in similar fashion such as seen in FIG. 20. For example, a subsequent layer 83 of cable 84 can be applied over the previous layer 83 and in contact with the polymer resin 89. The subsequent layer 83 of cable 84 can be saturated and covered with a subsequent coat of CA adhesive 91. The subsequent coat of CA adhesive 91 covering the subsequent layer 83 of cable 84 bonds to the previous coat of polymer resin 89 and therefore to the previous layer 83 of cable 84. This can bond two radial layers 83 of cable 84 together with polymer resin 89 being bonded to and between opposing coats of CA adhesive 91 covering the cables 84 of the radial layers 83. A thin layer of CA adhesive 91 can in some cases, extend over the previous coat of polymer resin 89. A subsequent coat of polymer resin 89 can then be applied over the subsequent coat of CA adhesive 91 in preparation for a new layer 83 of cable 84. Each layer 91a and 91b of CA adhesive 91, and layer of polymer resin 89 can be set or cured before proceeding with the next step.

FIGS. 17, 18, 20, 22 and 23 depict the application of multiple radial layers 83 of cable 84. FIG. 20 depicts layers of cable 84 that are vertically inline, but it is understood that the cable 84 can be staggered relative to each other. When the desired number of radial layers 83 has been applied, the end of the cable 84 can be secured, for example to a side 64 of the spool 80, such as in a hole, and an outer covering 63 of thermosetting polymer resin 89 can seal and encase the outermost layer 83 of cable 84. In one embodiment, when the polymer resin 89 is epoxy resin, the outer covering 63 can be a coat of epoxy resin mixed with polycarbonate powder or baking soda. After curing, the outer covering 63 can be ground smooth. In other embodiments, the outer covering 63 can include carbon fiber composites. For illustration on the number of layers 83 which can be employed, in one example, a flywheel 12 having a core 60 with a diameter of 36 inches and a composite rim 62 with a diameter of 120 inches, the composite rim 62 can have about 168 radial layers 83 of cable 84, when ¼ inch diameter cable 84 is used. During application of the cable 84 around the core 60, a large length of cable 84 can be required (thousands of feet), and ends of pieces of cable 84 can be joined together by butt welding or other suitable methods. If desired, multiple strands of cable 84 can be simultaneously applied to core 60 side by side, for example, from multiple spools 90, to speed up the winding process. If desired, the curing of the CA adhesives 91 and/or polymer resin 89 can be accelerated by the use of curing accelerators, for example UV light, or other suitable methods, but strength can be reduced. However, it is usually desirable to first allow the CA adhesive 91 and the polymer resin 89 to penetrate or saturate the layers 83 of cable 84 before accelerating curing. In some embodiments, the composite rim 62 can be constructed around a form, and then mounted to the desired shaft or core configuration. Constructing the composite rim 62 around the form can be done in a similar manner as described for core 60 and spool 80. Additionally, a core 60 or spool 80 can be used as a form.

In some embodiments, the flywheel 12 can be as small as 2 inches in diameter and 1 lb in weight. However, the construction of the composite rim 62 can allow flywheel 12 to be built with large diameters and weights, and rotated at high speeds, for example, ranging from 48 inches to 20 feet in diameter, 1700 lb to 50,000 lbs or even 70,000 lbs in weight, and 1000 rpm to 9000 rpm and above. Speeds such as 4000 rpm, 5000 rpm, 6000 rpm, 7000 rpm and 8000 rpm can be common. Speeds upwards of 12,000 rpm are possible. Common desired weights can be 10,000 lbs, 20,000 lbs, 30,000 lbs, 40,000 lbs, 50,000 lbs, 60,000 lbs and 70,000 lbs, depending upon the situation at hand. A flywheel 12 having a weight of about 70,000 lbs can have a core 60 with a diameter of about 90 inches, an outer diameter of about 10 feet, and can be about 48 inches in width. An outer diameter of 10 feet or less can allow the flywheel 12 to be easily transported by truck. Larger sizes and weights can be possible, for example, when building flywheel 12 on site. Typically, a large heavy metal flywheel will fail at high speeds. However, flywheel 12 can be constructed with a large diameter and heavy weight that can withstand the high forces encountered when rotating at high speed, for example, a flywheel having a diameter of at least 48 inches, a weight of at least 10,000 lbs and rotating at a speed of at least 1000 rpm.

CA adhesives 91 by itself, would likely be unable to hold the cable 84 together under the high forces that even a flywheel 12 having a diameter of 48 inches and a weight of 1700 lbs experiences during use at speeds of 1000 rpm and above. CA adhesive 91 can have a high strength bond with metal or steel, and in experimentation, it has been found that a normal viscosity CA adhesive 91 can have a bond strength with metal for example, up to approximately a 4000 PSI bondline. However, CA adhesive 91 is very brittle and during operation, would tend to crack, fracture or break, and be unable to keep the layers 83 of cable 84 bonded together. In addition, thermosetting polymer resin 89, such as epoxy resin or polycarbonate resin, by itself, would also likely be unable to hold the layers 83 of cable 84 together. For example, although polymer resin 89 such as epoxy resin and polycarbonate resin bonds well with metals or steel, epoxy resin and polycarbonate resin can delaminate from metals or steel as temperatures rise to the levels normally experienced by a rotating flywheel, and it has been found in experimentation that it can have a bond strength of only approximately a 500 PSI bondline or less.

However, it has been discovered by experimentation that thermosetting polymer resins 89 such as epoxy resin and polycarbonate resin, can form a higher strength bond to CA adhesive 91 than to metal, for example, approximately a 2000 PSI bondline and above. Furthermore, it has been discovered that CA adhesive 91 can be applied to form a high penetrating and extremely high strength bond with metal, for example, approximately a 4000 PSI bondline and above. Consequently, the combination of using a thermosetting polymer resin 89, for example, epoxy resin or polycarbonate resin, to bond adjacent CA adhesive 91 coated metal cables 84 together, can result in a much stronger composite than if those adhesives or resins were used separately to bond the cable 84. A composite rim 62 formed in such a manner is strong enough to construct a 20 foot diameter wheel 50,000 lbs and rotated at 9000 rpm or above. Furthermore, the CA adhesive 91 coating the cable 84 also forms a larger bonding surface area than on a bare cable metal 84 for the polymer resin 89 to bond or grip to, which can also increase the bond strength. A polymer resin 89 such as epoxy resin or polycarbonate resin is less brittle than the CA adhesive 91 and can compensate for some deflection or movement of cable 84 and reinforce the CA adhesive 91. Using multiple strand twisted cable 84 can further increase the bonding capability of the cables 84 due to increased bonding surface area formed by the surfaces of the multiple strands 84a and the crevices 84c in the multiple strand cable 84. Having strands 84a that are twisted at angles α (FIG. 15) relative to the length or longitudinal axis C of the cable 84, can aid the bonding capability by having multiple angled crevices 84c which can be mechanically supported or locked within the polymer resin 89. Also, the low viscosity CA adhesive 91 is thin enough to penetrate and fill small crevices on the surface of the metal strands 84a and between cable strands 84a, and can penetrate coatings on the metal strands 84a, which can increase the bonding surface area and provide stronger gripping and bonding of the CA adhesive 91 to each strand 84a. Since the low or lower viscosity CA adhesive 91 is thin, the higher viscosity CA adhesive 91 can provide a larger surface area for the polymer resin 89 to bond to. Referring to FIG. 20, in some situations, a radial layer of CA adhesive 91 can also separate each radial layer of polymer resin 89 from each other. As a result, the composite rim 62 can also include regions of radially adjacent layers of polymer resin 89 bonded to each other by being bonded to a radial layer of CA adhesive 91 that is in between. This can increase the strength of the composite rim 62 in the spaces 87 between the cables 84.

The steel cable 84 of the composite rim 62 can structurally hold the core 60 together from rotational forces and can form most of the weight of the flywheel 12 in an annular ring at the outer perimeter of the flywheel 12. The flywheel 12 can be positioned upright, rotating about horizontal axis A, which allows the weight of the rim 62 to be radially supported by the core 60 and horizontal shaft 58. This can allow the flywheel 12 to have a large diameter and weight, and additionally a large diameter to width ratio, for example 2:1, or in other embodiments, 5:1. By having a large amount of weight at the perimeter of a large diameter to width ratio wheel, flywheel 12 can have a large moment of inertia and is able to maintain speed longer than flywheels having small diameters, having outer perimeters of light materials such as carbon fiber composites, or having a small diameter to width ratio. It has been found in experimentation that there is a relationship between the mass M of the flywheel and the time T of the rotation possible before stopping, where Δmass≈ΔT. It has been found that about each 19 lbs of weight, increases run down time of the flywheel 12 approximately one minute under no load conditions.

In addition, more than one type size, or material for cable 84 can be used, for example, one size, type or material on the inner diameter portion of rim 62, and the other on the outer diameter portion. For example, an outer portion of rim 62, for example, the last radial 6 inches, can be formed with cable 84 having a smaller diameter than cable 84 used on the inner diameter portion of the rim 62. The use of a smaller diameter cable 84 on the outer portion can reduce the size of the cavities 87 between the cables 84, thereby increasing the density and weight of the outer diameter portion of the rim 62 relative to the inner diameter portion. Increased weight on the rim 62 can increase the moment of inertia and the run down time of flywheel 12 when operating.

The metal cable 84, CA adhesive 91 and polymer resin 89 combination forming composite rim 62 can dampen or suppress vibration or harmonics. Generally surrounding each cable 84 with CA adhesive 91 and polymer resin 89 can suppress vibration propagation laterally and radially across the composite rim 62. Using multistrand cable 84 can also aid in vibration suppression. Flexibility of the cable 84 and deflection of the surrounding polymer resin 89 can provide some self balancing during rotation. In addition, having a core 60 formed of laminated composite materials such as sheets of polycarbonate laminated together with epoxy or other resin, can suppress or dampen vibration propagation across the core 60. Core 60 can be made of other suitable materials and can include other vibration damping materials or constructions as well as metals. In some embodiments, core 60 can be omitted, and composite rim 62 can be formed around or mounted to shaft 58. Alternatively, core 60 can be formed of composite fiber materials which can have a wound fiber composite construction similar to composite rim 62 and can use different materials, including non-metallic fibers such as polymeric, natural and carbon. Furthermore, in other embodiments, the layers 83 of cable 84 can be replaced with radial layers of wound metallic sheet, ribbon, screen, mesh, chain or chain link, etc., and include types of metal other than steel.

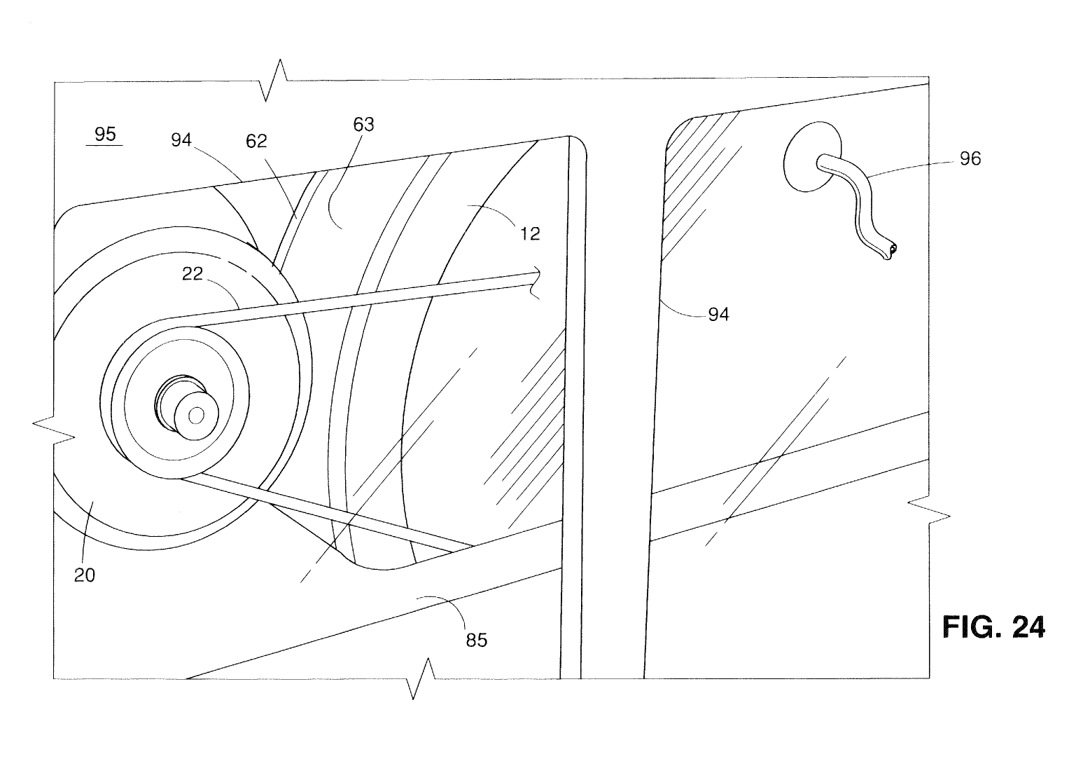

Referring to FIG. 24, the flywheel device 10 can include an enclosure 95 for housing at least the flywheel 12. Other components such as generator 20 and motors 14 and 18 can also be housed within enclosure 95. The enclosure 95 can contain the flywheel 12 in the event of a mechanical flywheel failure, and additionally, can surround the flywheel 12 in a low density environment, for example, helium or a vacuum, for reducing resistance to the flywheel 12 when spinning. The enclosure 95 is shown with windows 94, but in most embodiments, windows can be omitted. A tube or hose 96 can be connected to the housing 95 for introducing a low density gas, for example helium, or for evacuating gases to form a vacuum. The vacuum can be a partial vacuum.

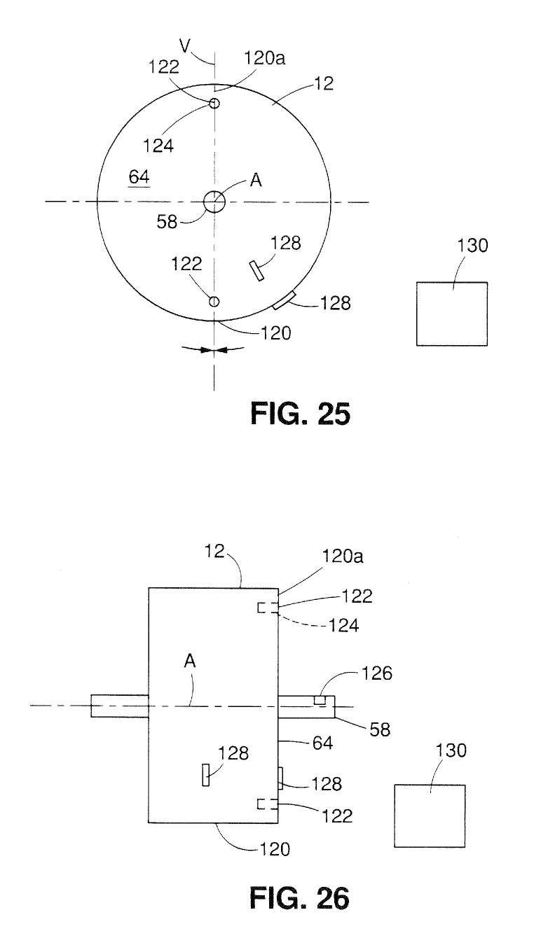

Referring to FIGS. 25 and 26, flywheel 12 can be balanced before use. The flywheel 12 can be rotatably supported along horizontal axis A, for example, by the horizontal shaft 58 which in turn can be supported by bearings 78. The flywheel 12 can be first statically balanced. If the flywheel 12 has a heavy side 120, the heavy side 120 of the flywheel 12 can be allowed to rotate to the bottom position. Static balancing can be achieved by adding weight to the top position 120a opposite to the bottom position or heavy side 120 on the flat lateral side of the flywheel 12, or removing weight from the side of the flywheel 12 at the heavy side 120 or bottom position. Adding weight can be accomplished by drilling a hole 122 in the side of flywheel 12 and then inserting and bonding a metal plug 124 in the hole 122. Removing weight can be achieved by drilling a hole 122 in the side and either leaving the hole 122 open, or inserting and bonding a light weight plug 124 in the hole 122. The hole 122 can be drilled into sides 64. After static balancing, the flywheel 12 can be dynamically balanced to provide further balancing.

For dynamic balancing, a sensor 126 can be applied to the flywheel 12, for example, on the shaft 58 and laser reflective materials can be applied to the side or diameter of the flywheel 12. The flywheel 12 can then be rotated from about 100 rpm to 700 rpm while being monitored with a laser balancing system. The laser balancing system can indicate locations for adding or removing weight, which can be accomplished in the manner previously discussed.

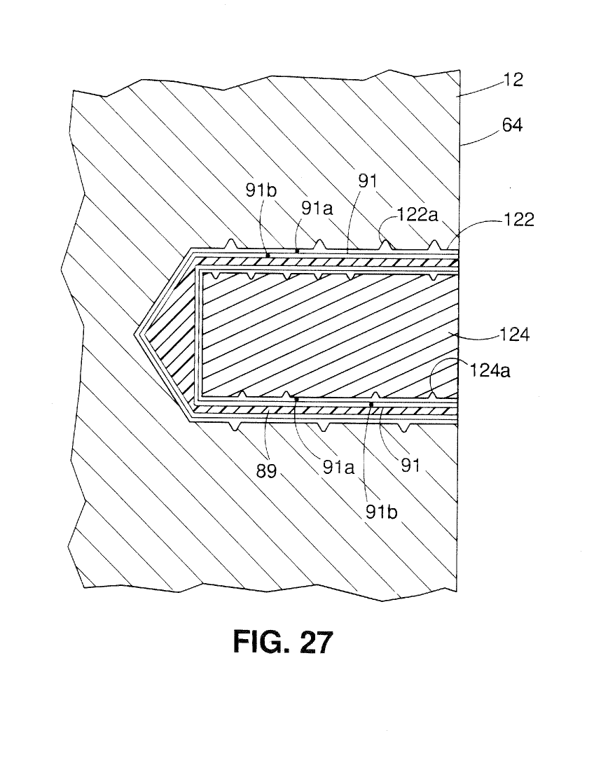

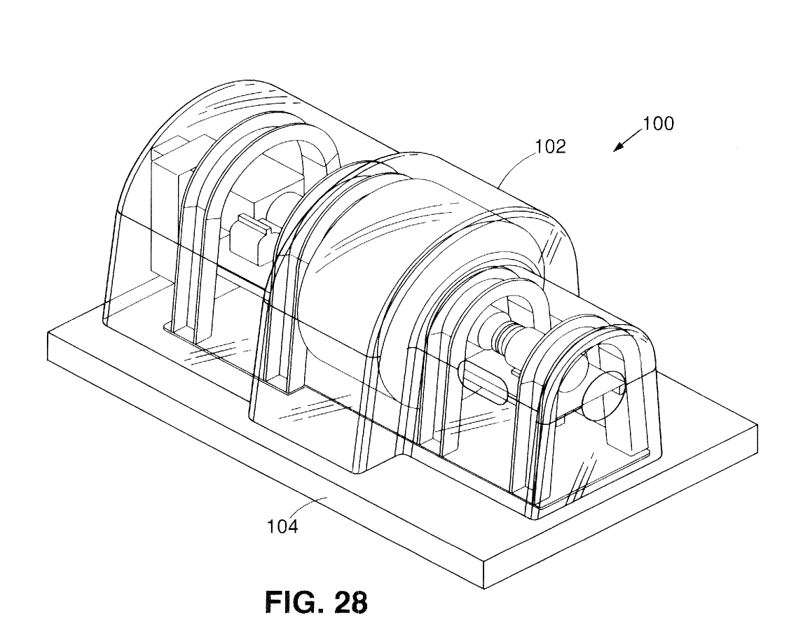

Referring to FIG. 27, for bonding a plug 124 within a hole 122, the surfaces within the hole 122 and surfaces over the plug 124 can be covered with a coat of cyanoacrylate (CA) type adhesive 91. The coated plug 124 can then be bonded within the coated hole 122 by a polymer resin 89, such as epoxy resin or polycarbonate resin. The polymer resin 89 bonds the coat of CA adhesive 91 covering the hole 122 to the coat of CA adhesive 91 covering the plug 124. The coat of CA adhesive 91 can be applied in two layers. The first layer 91a of CA adhesive 91 can have a low or lower viscosity for penetrating and bonding to the surfaces of the hole 122 and plug 124, and to fill small cavities 122a and 124a in the surfaces on the hole 122 and plug 124. A second layer 91b of CA adhesive 91 with a higher viscosity can be applied over the first layer 91a in the hole 122 and on the plug 124 for further bonding and filling and for providing a larger surface area for the polymer resin 89 to bond to. The plug 124 can then be secured within hole 122 with polymer resin 89 which bonds the coat of CA adhesive 91 covering the surfaces of the hole 122 to the coat of CA adhesive 91 covering the plug 124, thereby providing strong and secure bonding. The plug 124 can be inserted into a lateral side of the flywheel 12, such as in side 64, parallel to the horizontal axis A of the flywheel 12, whereby centrifugal forces exerted on the plug 124 are resisted by the sidewalls of the hole 122. The plug 124 when formed of metal or metallic material, can be any suitable metal, such as steel, iron, copper, lead, etc. In some embodiments, hole 122 can be a female threaded hole, and plug 124 can have a male thread, for mechanical engagement. In some embodiments, plug 124 can be a bolt, screw, or set screw. In some situations, only one of the hole 122 or the plug 124 can be coated with CA adhesive 91.

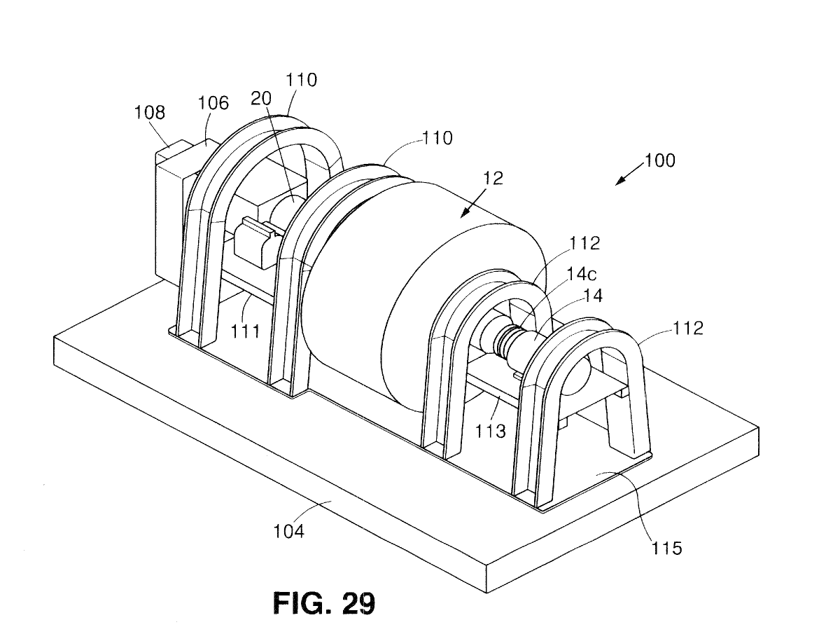

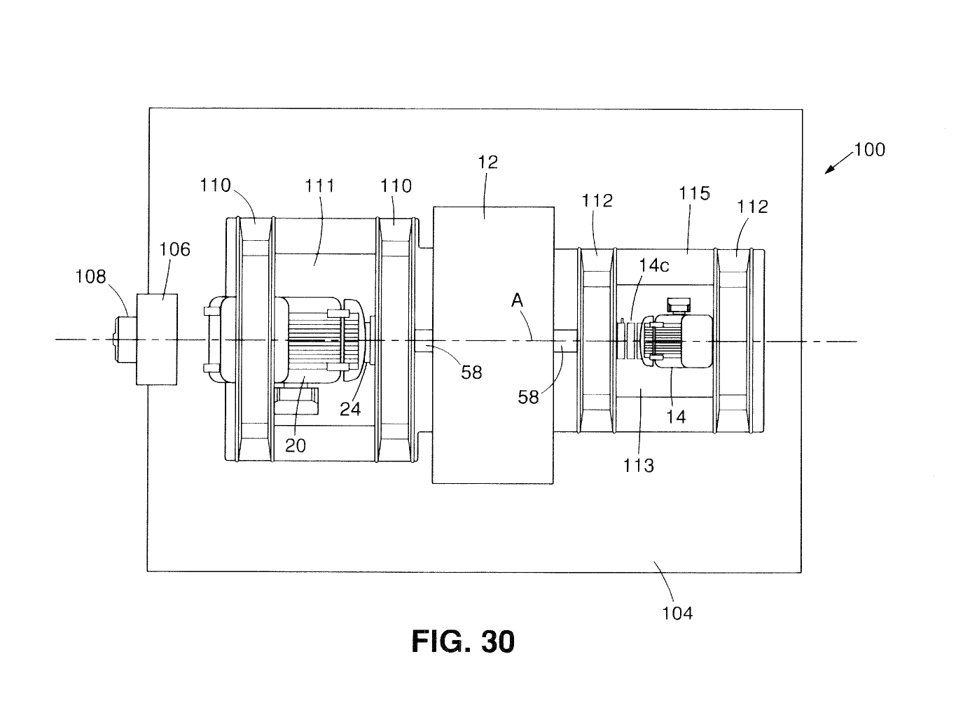

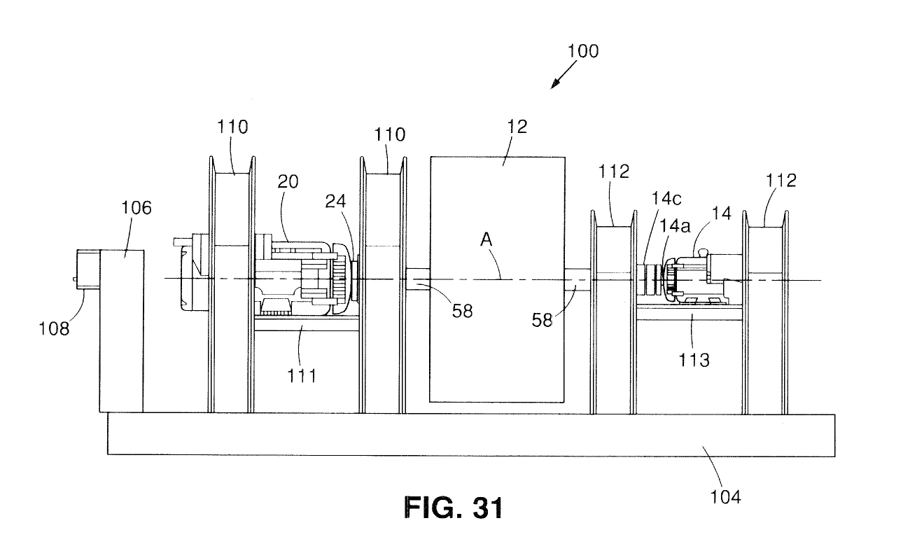

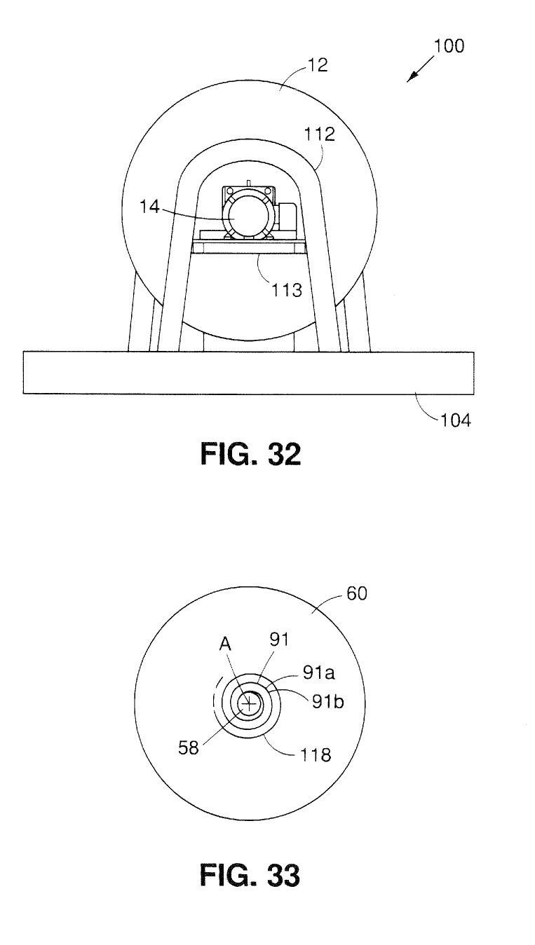

Referring to FIGS. 28-32 flywheel device, apparatus or system 100 is another embodiment in the present invention. Flywheel device 100 can differ from device 10 in that flywheel device 100 can include arched frame members 110 and 112 for rotatably supporting flywheel 12 upright about horizontal axis A. Motor 14 can be supported on a base plate 113 between two frame members 112 and can be used to bring flywheel 12 up to speed. The drive shaft 14a of motor 14 can be positioned axially inline with horizontal axis A and horizontal shaft 58, and can be rotatably connectable or engageable with shaft 58 by a clutch 14c for driving flywheel 12. Clutch 14c can rotatably disengage motor 14 from flywheel 12, such as when flywheel 12 is driving generator 20 and being run down. If desired, motor 14 can be connected to or include a transmission or gear box. Generator 20 can be supported on a base plate 111 between two frame members 110 and can also be aligned with horizontal axis A and horizontal shaft 58. The generator 20 can be rotatably connectable or engageable to flywheel 12 by a clutch 24 to be driven by flywheel 12 for generating electrical power. Clutch 24 can rotatably disengage flywheel 12 and generator 20 from each other, such as when flywheel 12 is brought up to speed by motor 14. Clutches 14c and 24 can be any suitable clutches as known in the art, such as mechanical, electromagnetic, fluid, etc. The flywheel device 100 can be operated and controlled by a control panel 106. The control panel 106 can have a user interface 108, which can include a screen, keyboard, buttons, etc. The control panel 106 can include a controller 26 for controlling the operation of the motor 14 and generator 20, an electrical power regulator 30 for controlling, regulating or transforming the electrical output form generator 20, and a disconnect regulator 44. Clutches 14c and 24 can also be controlled by controller 26. The size, style specifications, or configuration of motor 14, flywheel 12, generator 20, controller 26, electrical power regulator 30 and disconnect regulator 44 can vary, for example, such as previously discussed. In addition, the size of motor 14 and generator 20 can increase in size with increases in the size of flywheel 12. A mechanical brake can be used to slow or stop flywheel 12. In addition, motor 14 can be used as a brake. The frame members 110 and 112 can be mounted to a base 115 which can also be mounted to a concrete pad 104. A housing 102 can cover, house or contain the flywheel 12, motor 14 and generator 20. In some embodiments, only the flywheel 12 is housed within housing 102. The motor 14 can be omitted and the generator 20 can be used as a motor/generator. The housing 102 can have a low density environment surrounding the flywheel 12, such as helium or a vacuum.

FIG. 33 depicts another embodiment of a core 60 for flywheel 12, which can be formed by attaching and winding a sheet or web 118 of fiber material around shaft 58 and axis A, and bonding together with CA adhesive 91 to form a composite core. The web 118 can in one embodiment, be a double loop nylon material with a weave similar to seat belt material, and can approximately the same width as the flywheel 12, for example, in one embodiment is 48 inches wide. The web 118 can have a thickness of about 1/16 to ⅛ inches. It is understood that other materials, weaves, widths and thicknesses can be used. The end or edge of web 118 can be adhered to the shaft 58 by CA adhesive 91, for example, about ¼ inch with instant set CA adhesive 91. The web 118 can then be wound in one or multiple layers, for example, three layers and stopped. A first layer 91a of thin, low or lower viscosity CA adhesive 91 can then saturate the layer(s) of web 118. The shaft 58 can be rotated about 360° one direction and about 360° back while the CA adhesive 91 is being applied, to saturate the web 118 through to the shaft 58, and not drip off. After the first layer 91a is set, a second layer 91b of CA adhesive 91, with a higher viscosity, such as medium viscosity or medium set adhesive with about a 5-20 second set time, can be applied to fill gaps, including those on the surfaces. This process is repeated, which can be three layers at a time, until the desired diameter of the core 60 is obtained. The number of layers bonded at a time can depend upon the thickness of the web 118. The web 118 can be laid flat to bond securely to the underlying layers. After curing, the core 60 can be turned slowly on a lathe to machine the sides and diameter to make true and consistent, which can also provide some balancing. A smooth diameter can form a consistent bed on which the cable 84 can be evenly applied. Once turned down, the core 60 can be covered with a layer (can be two layers) of high viscosity slow set CA adhesive 91 with a set time of 60 seconds or more. The CA adhesives 91 for the core can be applied without an accelerator to ensure strength. The resulting composite laminate core can have a high strength of uniform density. The web 118 can have multiple weave directions, which can resist twisting and warping.

While this invention has been particularly shown and described with references to example embodiments thereof, it will be understood by those skilled in the art that various changes in form and details may be made therein without departing from the scope of the invention encompassed by the appended claims.

For example, although embodiments of flywheel 12 have been shown and described for rotation about a horizontal axis, in other embodiments, flywheel 12 can be constructed to rotate about a vertical axis. In addition, in some embodiments two layers 91a of low or lower viscosity CA adhesive 91 can be used instead of a first layer 91a of lower viscosity and a second layer 91b of higher viscosity. Furthermore, although epoxy resin and polycarbonate resin have been given as examples of thermosetting polymer resin 89, it is understood that other thermosetting polymer resins can be used or included. Also, the flywheel device 10 and flywheel 12 can have components or parts made of composite materials including a substrate material having fibers, which can be metallic, nonmetallic, polymeric, natural, carbon, etc., covered by a first layer 91a of low or lower viscosity CA adhesive 91, and a second layer 91b of higher viscosity CA adhesive 91.

What is claimed is:

1. A flywheel device having a rotatable wheel comprising:
a rotatable composite rim structure comprising multiple radial layers of metallic material, the metallic material having surfaces covered with a coat of cyanoacrylate type adhesive, radially adjacent layers of the metallic material being bonded together with a thermosetting polymer resin bonded to and between opposing coats of cyanoacrylate type adhesive covering the surfaces of the metallic material.

2. The flywheel device of claim 1 further comprising a core member having an outer perimeter, the composite rim structure being formed over the outer perimeter of the core member, the multiple radial layers of the metallic material extending around the core member.

3. The flywheel device of clam 2 in which the metallic material comprises metallic fibers wound around the core member.

4. The flywheel device of claim 3 in which each layer of the metallic material comprises twisted multiple strand metal wire cable positioned side by side.

5. The flywheel device of claim 4 in which each layer of the metallic material has laterally adjacent cable bonded together with the thermosetting polymer resin.

6. The flywheel device of claim 5 in which the coat of cyanoacrylate type adhesive has a first layer and a second layer, the first layer having a lower viscosity for penetrating into and between the multiple strands of the cable for bonding to and filling between the strands and to fill small cavities in the strands, the second layer covering the first layer and having a higher viscosity for further bonding and filling and providing a larger surface area for the thermosetting polymer resin to bond to.

7. The flywheel device of claim 6 in which the thermosetting polymer resin is selected from the group consisting of epoxy resin and polycarbonate resin.

8. The flywheel device of claim 2 in which the core member comprises polymeric material.

9. The flywheel device of claim 2 in which the core member comprises composite material.

10. The flywheel device of claim 2 further comprising two side walls on opposite sides of the core member and the composite rim structure.

11. The flywheel device of claim 10 in which the core member and the side walls are formed of sheets of polycarbonate material laminated together with epoxy and clamped together with fasteners.

12. The flywheel device of claim 2 in which the rotatable wheel further comprises a horizontal support shaft extending through the core member for supporting and for rotating said wheel about a horizontal axis.

13. The flywheel device of claim 12 further comprising a motor rotatably connectable to the rotatable wheel for rotating said wheel to a desired speed.

14. The flywheel device of claim 13 further comprising an electric generator rotatably connectable to the rotatable wheel for being rotated by the rotatable wheel.

15. The flywheel device of claim 14 further comprising a clutch connected between at least one of the motor, the generator and the rotatable wheel.

16. The flywheel device of claim 15 further comprising an enclosure containing at least the rotatable wheel and surrounding the rotatable wheel in a low density environment.

17. The flywheel device of claim 1 in which the rotatable wheel has a diameter to width ratio of at least 2:1.

18. The flywheel device of claim 1 in which the rotatable wheel has an outer diameter of at least 48 inches, a weight of at least 1700 lb. and is capable of rotating at a speed of at least 1000 rpm.

19. The flywheel device of claim 18 in which the rotatable wheel has a weight of at least 10,000 lb.

20. The flywheel device of claim 19 in which the rotatable wheel has a weight of at least 20,000 lb.

21. The flywheel device of claim 20 in which the rotatable wheel has a weight of at least 30,000 lb.

22. The flywheel device of claim 21 in which the rotatable wheel has an outer diameter of at least 72 inches.

23. The flywheel device of claim 18 in which the rotatable wheel is capable of rotating above 9000 rpm.

24. A flywheel device having a rotatable wheel comprising:
a composite core member having an outer perimeter; and
a composite rim structure formed over the outer perimeter of the core member, the composite rim structure comprising twisted multiple strand metal wire cable positioned side by side and wound around the core member in multiple layers, the cable having surfaces covered with a coat of cyanoacrylate type adhesive, laterally adjacent cable and radially adjacent layers of the cable being bonded together with a thermosetting polymer resin bonded to and between opposing coats of cyanoacrylate type adhesive covering the surfaces of the cable, the coat of cyanoacrylate type adhesive having a first layer and a second layer, the first layer having a lower viscosity for penetrating into and between the multiple strands of the cable for bonding to and filling between the strands and to fill small cavities in the strands, the second layer covering the first layer and having a higher viscosity for further bonding and filling and providing a larger surface area for the thermosetting polymer resin to bond to.

25. A composite structure comprising:
a material having fibers;
a first layer of cyanoacrylate type adhesive covering the material, said first layer having a lower viscosity for penetrating into and between the fibers for bonding to and filling between the fibers and to fill small cavities in the fibers; and
a second layer of cyanoacrylate type adhesive covering the first layer of cyanoacrylate type adhesive, said second layer having a higher viscosity for providing further bonding and filling.

26. The composite structure of claim 25 in which the material having fibers comprises twisted multiple strand metal wire cable.

27. The composite structure of claim 25 in which the material having fibers is a web wound and bonded into a composite material core.

28. A method of forming a flywheel device comprising:
assembling multiple radial layers of metallic material;
covering surfaces of the metallic material with a coat of cyanoacrylate type adhesive; and
bonding radially adjacent layers of the metallic material together with a thermosetting polymer resin bonded to and between opposing coats of cyanoacrylate type adhesive covering the surfaces of the metallic material, thereby forming a rotatable wheel having a composite rim structure.

29. The method of claim 28 further comprising forming the composite rim structure over an outer perimeter of a core member by extending the multiple radial layers of the metallic material around the core member.

30. The method of claim 29 further comprising forming each layer of the metallic material by winding metallic fibers around the core member.

31. The method of claim 30 further comprising forming each layer of the metallic material by winding twisted multiple strand metal wire cable side by side and bonding laterally adjacent cable together with the thermosetting polymer resin.

32. The method of claim 28 in which bonding radially adjacent layers of the metallic material comprises:
winding an underlying layer of metallic material;
covering surfaces of the underlying layer of metallic material with an underlying coat of cyanoacrylate type adhesive;
covering the underlying coat of cyanoacrylate type adhesive on the underlying layer of metallic material with a bonding coat of polymer thermosetting resin;
winding a subsequent layer of metallic material over the underlying layer of metallic material and contacting the bonding coat of polymer thermosetting resin; and
covering surfaces of the subsequent layer of metallic material with a subsequent coat of cyanoacrylate type adhesive, thereby bonding the subsequent coat of cyanoacrylate type adhesive and the subsequent layer of metallic material to the bonding coat of polymer thermosetting resin.

33. The method of claim 32 further comprising:
curing the underlying coat of cyanoacrylate type adhesive before applying the bonding coat of polymer thermosetting resin; and
curing the bonding coat of polymer thermosetting resin before winding the subsequent layer of metallic material over the underlying layer of metallic material and the bonding coat of thermosetting polymer resin.

34. The method of claim 31 in which covering the surfaces of the metallic material with the coat of cyanoacrylate type adhesive comprises;
covering the surfaces with a first layer of cyanoacrylate type adhesive having a lower viscosity for penetrating into and between the multiple strands of the cable for bonding to and filling between the strands and to fill small cavities in the strands; and
covering the first layer of cyanoacrylate type adhesive with a second layer of cyanoacrylate type adhesive having a higher viscosity for further bonding and filling and providing a larger surface area for the thermosetting polymer resin to bond to.

35. The method of claim 34 further comprising bonding the radially adjacent layers of the metallic material with a thermosetting polymer resin selected from the group consisting of epoxy resin and polycarbonate resin.

36. The method of claim 29 further comprising forming the core member from polymeric material.

37. The method of claim 29 further comprising forming the core member from composite material.

38. The method of claim 29 further comprising securing two side walls on opposite sides of the core member.

39. The method of claim 38 further comprising forming the core member and the side walls from sheets of polycarbonate material laminated together with epoxy and clamped together with fasteners.

40. The method of claim 29 further comprising extending a horizontal support shaft through the core member for supporting and rotating the rotatable wheel about a horizontal axis.

41. The method of claim 40 further comprising providing a motor that is rotatably connectable to the rotatable wheel for rotating said wheel to a desired speed.

42. The method of claim 41 further comprising providing an electric generator that is rotatably connectable to the rotatable wheel for being rotated by the rotatable wheel.

43. The method of claim 42 further comprising rotatably connecting a clutch between at least one of the motor, generator, and the rotatable wheel.

44. The method of claim 43 further comprising containing at least the rotatable wheel within an enclosure and surrounding the rotatable wheel in a low density environment.

45. The method of claim 28 further comprising forming the rotatable wheel with a diameter to width ratio of at least 2:1.

46. The method of claim 28 further comprising forming the rotatable wheel with an outer diameter of at least 48 inches, a weight of at least 1700 lb, and capable of rotating at a speed of at least 1000 rpm.

47. The method of claim 46 further comprising forming the rotatable wheel with a weight of at least 10,000 lb.

48. The method of claim 47 further comprising forming the rotatable wheel with a weight of at least 20,000 lb.

49. The method of claim 48 further comprising forming the rotatable wheel with a weight of at least 30,000 lb.

50. The method of claim 49 further comprising forming the rotatable wheel with an outer diameter of at least 72 inches.

51. The method of claim 46 further comprising forming the rotatable wheel to be capable of rotating above 9000 rpm.

52. A method of forming a flywheel device comprising:
forming a composite core member having an outer perimeter;
winding multiple layers of twisted multiple strand metal wire cable positioned side by side around the outer perimeter of the core member;
covering surfaces of the cable with a coat of cyanoacrylate type adhesive;
bonding laterally adjacent cables and radially adjacent layers of the cable with a thermosetting polymer resin bonded to and between opposing coats of cyanoacrylate type adhesive covering the surfaces of the cable, the coat of cyanoacrylate type adhesive having a first layer and a second layer, the first layer having a lower viscosity for penetrating into and between the multiple strands of the cable for bonding to and filling between the strands and to fill small cavities in the strands, the second layer covering the first layer and having a higher viscosity for further bonding and filling and providing a larger surface area for the thermosetting polymer resin to bond to, thereby forming a rotatable wheel having a composite rim structure formed over the core member.

53. A method of forming a composite structure comprising:
covering a material having fibers with a first layer of cyanoacrylate type adhesive having a lower viscosity for penetrating into and between the fibers for bonding to and filling between the fibers and to fill small cavities in the fibers; and
covering the first layer of cyanoacrylate type adhesive with a second layer of cyanoacrylate type adhesive having a higher viscosity for providing further bonding and filling.

54. The method of claim 53 further comprising covering twisted multiple strand metal wire cable.

55. The method of claim 53 in which the material having fibers is a web, the method further comprising winding and bonding the web into a composite material core.

56. A method of balancing a flywheel comprising:
rotatably supporting the flywheel about a horizontal axis;
statically balancing the flywheel by allowing a heavy side of the flywheel to rotate to a bottom position and adding weight to a top position or removing weight at the bottom position; and
dynamically balancing the flywheel with a laser balancing system by applying sensor and laser reflective materials to the flywheel, rotating the flywheel from about 100 to 700 rpm, and adding or removing weight indicated by the laser balancing system by drilling at least one hole in a side of the flywheel at indicated locations and when adding weight, inserting at least one weighted member in the at least one hole.

57. The method of claim 56 in which the at least one weighted member is at least one metallic member, the method further comprising:
covering surfaces of the at least one hole and the at least one metallic member each with a coat of cyanoacrylate type adhesive; and
securing the at least one metallic member within the at least one hole with thermosetting polymer resin bonding the coat of cyanoacrylate type adhesive covering the at least one hole to the coat of cyanoacrylate type adhesive covering the at least one metallic member.

58. The method of claim 57 further comprising applying said coat of cyanoacrylate type adhesive in first and second layers, the first layer having a lower viscosity for penetrating and bonding to said surfaces and filling small cavities in said surfaces, and the second layer having a higher viscosity for further bonding and filling and providing a larger surface area for the thermosetting polymer resin to bond to.

59. The method of claim 58 further comprising employing a thermosetting polymer resin selected from the group consisting of epoxy resin and polycarbonate resin.

60. A method of suppressing vibration in a flywheel rotating about a horizontal axis comprising:
providing the flywheel with a composite core member for limiting vibration propagation across the core member;
providing the flywheel with a composite rim structure formed around the core member having metallic material wound around the core member in multiple layers, the metallic material having surfaces covered with a coat of cyanoacrylate type adhesive, radially adjacent layers of the metallic material being bonded together with a thermosetting polymer resin bonded to and between opposing coats of cyanoacrylate type adhesive covering the surfaces of the metallic material for limiting vibration propagation across the rim structure.

61. A method of storing energy comprising:
providing a composite flywheel having an outer diameter of at least 48 inches and a weight of at least 10,000 lb; and
rotating the flywheel about a horizontal axis at a speed of at least 1000 rpm.

62. The method of claim 61 further comprising providing the flywheel with a weight of at least 20,000 lb.

63. The method of claim 62 further comprising providing the flywheel with a weight of at least 30,000 lb.

64. The method of claim 63 further comprising providing the flywheel with an outer diameter of at least 72 inches.

65. The method of claim 61 further comprising rotating the flywheel above 9000 rpm.

66. The method of claim 61 further comprising providing the flywheel with a composite rim structure having multiple radial layers of metallic material, the metallic material having surfaces covered with a coat of cyanoacrylate type adhesive, radially adjacent layers of the metallic material being bonded together with a thermosetting polymer resin bonded to and between opposing coats of cyanoacrylate type adhesive covering the surfaces of the metallic material.

67. The method of claim 66 further comprising providing the flywheel with a core member formed of sheets of polymeric material.
